(19) United States
(12) Patent Application Publication
(10) Pub. No.: US 2026/0067703 A1
(43) Pub. Date: Mar. 5, 2026

(54) CHANNEL ACCESS BLOCKING REDUCTION FOR A SIDELINK COMMUNICATION ON RESOURCES OF AN UNLICENSED SPECTRUM

(71) Applicant: Fraunhofer-Gesellschaft zur Förderung der angewandten Forschung e.V., München (DE)

(72) Inventors: Thomas WIRTH, Berlin (DE); Thomas FEHRENBACH, Berlin (DE); Baris GÖKTEPE, Berlin (DE)

(21) Appl. No.: 19/383,877

(22) Filed: Nov. 10, 2025

Related U.S. Application Data
(63) Continuation of application No. PCT/EP2024/062614, filed on May 7, 2024.

(30) Foreign Application Priority Data
May 12, 2023 (EP) 23173210.8

(51) Int. Cl. H04W 16/14; H04W 48/02; H04W 74/0808

(52) U.S. Cl. CPC H04W 16/14; H04W 48/02; H04W 74/0808

(57) ABSTRACT

A user device, UE, for a wireless communication network is described, which is to communicate with one or more further UEs in the wireless communication network using resources in an unlicensed spectrum. For a transmission on a first set of resources in the unlicensed spectrum, the UE is to determine whether or not one or more resources of the first set of resources are reserved by a further UE for performing a certain transmission. Responsive to determining that one or more resources of the first set of resources are reserved, the UE is to perform an action, the action comprising one or more of the following:
performing COT sharing,
performing COT deferral,
modifying the transmission,
notifying another device, e.g., a base station or RSU or another UE.

### CROSS-REFERENCE TO RELATED APPLICATIONS

This application is a continuation of copending International Application No. PCT/EP2024/062614, filed May 7, 2024, which is incorporated herein by reference in its entirety, and additionally claims priority from European Application No. EP 23173210.8, filed May 12, 2023, which is also incorporated herein by reference in its entirety.

The present invention concerns the field of wireless communication systems or networks, like 3^{rd} Generation Partnership Project, 3GPP, networks and non-3GPP networks, more specifically a direct communication between user devices using resources in the unlicensed spectrum. Embodiments concern approaches for reducing or resolving a blocking of a channel access, when a one user device, UE, performing a channel access procedure, CAP, is blocked due to a transmission of another UE.

### BACKGROUND OF THE INVENTION

FIG. 1 is a schematic representation of an example of a terrestrial wireless network 100 including, as is shown in FIG. 1(A), the core network 102 and one or more radio access networks RAN₁, RAN₂, . . . RAN_{N}. FIG. 1(B) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. The term base station may refer to an access point, AP, in any of the WiFi standards, e.g., belonging to the IEEE 802.11-familiy. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(B) shows an exemplary view of five cells, however, the RANₙ may include more or less such cells, and RANₙ may also include only one base station. FIG. 1(B) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(B) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1(B) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 1(B) by the arrows pointing to “gNBs”. A sidelink channel allows direct communication between UEs, also referred to as device-to-device, D2D, communication. The sidelink interface in 3GPP is named PC5. Note, that the term user equipment, UE, or user device may also refer to a station, STA, as used in any of the WiFi standards, e.g., belonging to the IEEE 802.11-familiy.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2^{nd} -stage SCI which refers to a first control region containing some parts of the SCI, also referred to as the 1^{st}-stage SCI, and optionally, a second control region which contains a second part of control information, also referred to as the 2^{nd}-stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with 3GPPs LTE, LTE-Advanced, LTE-Advanced Pro, or the 5G or 5G-Advanced or 3GPPs NR, New Radio, or within LTE-U, LTE Unlicensed or NR-U, New Radio Unlicensed, which is specified within the LTE and within NR specifications.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro or 5G or 5G-Advanced or NR, New Radio, or a possible future 6G radio system.

In mobile communication networks, for example in a network like that described above with reference to FIG. 1, like an LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are necessarily outside one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

FIG. 2(A) is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X. Thus, in Mode 1, a SL UE, e.g., UE 202 is connected via Uu interface to the gNB, and the gNB coordinates the resources for UE 202 be used to transmit control and/or data to another UE, e.g., UE 204, via a SL interface, which is referred to in NR as PC5.

FIG. 2(B) is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 2(B) which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 2(A), in addition to the NR mode 1 or LTE mode 3 UEs 202, 204 also NR mode 2 or LTE mode 4 UEs 206, 208, 210 are present. In addition, FIG. 2(B), schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210. Thus, the SL UEs, e.g., UEs 206-210, need not to have a connectivity to the gNB, and perform a sensing & access resource allocation or a random access-based resource allocation, e.g., when transmitting from UE 206 to UE 208. Nevertheless, basic configurations need to be available for the UEs 206-210, in order to successfully exchange data. This information may be pre-configured or may be configured while a UE is within coverage of the gNB. For this the gNB may provide a basic configuration, e.g., basic information, which may be transported via a broadcast channel, e.g., using system information blocks (SIBs). The BS may also assist Mode 2 UEs to provide basic information on which resource pool (RP) is to be used or may act as a synchronization source.

Although FIG. 2(A) and FIG. 2(B) illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

In the above-described scenarios of vehicular user devices, UEs, a plurality of such user devices may form a user device group, also referred to simply as group, and the communication within the group or among the group members may be performed via the sidelink interfaces between the user devices, like the PC5 interface. For example, the above-described scenarios using vehicular user devices may be employed in the field of the transport industry in which a plurality of vehicles being equipped with vehicular user devices may be grouped together, for example, by a remote driving application. Other use cases in which a plurality of user devices may be grouped together for a sidelink communication among each other include, for example, factory automation and electrical power distribution. In the case of factory automation, a plurality of mobile or stationary machines within a factory may be equipped with user devices and grouped together for a sidelink communication, for example for controlling the operation of the machine, like a motion control of a robot. In the case of electrical power distribution, entities within the power distribution grid may be equipped with respective user devices which, within a certain area of the system may be grouped together so as to communicate via a sidelink communication with each other so as to allow for monitoring the system and for dealing with power distribution grid failures and outages.

It is noted that the information in the above section is only for enhancing the understanding of the background of the invention and, therefore, it may contain information that does not form conventional technology that is already known to a person of ordinary skill in the art.

Starting from the above, there may be a need for improvements or enhancements of the sidelink in a wireless communication system or network.

### SUMMARY

An embodiment may have a user device, UE, for a wireless communication network, wherein the UE is to communicate with one or more further UEs in the wireless communication network using resources in an unlicensed spectrum, wherein, for a transmission on a first set of resources in the unlicensed spectrum, the UE is to determine whether or not one or more resources of the first set of resources are reserved by a further UE for performing a certain transmission, and wherein, responsive to determining that one or more resources of the first set of resources are reserved by the further UE for performing the certain transmission, the UE is to perform COT sharing by occupying a channel within a first channel occupancy time, COT, and sharing the remaining COT of the first COT with the further UE, so as to allow the further UE to perform its certain transmission.

According to another embodiment, a method for operating a user device, UE, for a wireless communication network, wherein the UE is to communicate with one or more further UEs in the wireless communication network using resources in an unlicensed spectrum, may have the steps of: determining, for a transmission on a first set of resources in the unlicensed spectrum, whether or not one or more resources of the first set of resources are reserved by a further UE for performing a certain transmission, and responsive to determining that one or more resources of the first set of resources are reserved by the further UE for performing the certain transmission, performing COT sharing by occupying a channel within a first channel occupancy time, COT, and sharing the remaining COT of the first COT with the further UE, so as to allow the further UE to perform its certain transmission.

### BRIEF DESCRIPTION OF THE DRAWINGS

Embodiments of the present invention will be detailed subsequently referring to the appended drawings, in which:

FIG. 1(A)-(B) illustrate a wireless communication network, wherein FIG. 1(A) is a schematic representation of an example of a terrestrial wireless network, and FIG. 1(B) is a schematic representation of an example of a radio access network, RAN;

FIG. 2(A) is a schematic representation of an in-coverage scenario;

FIG. 2(B) is a schematic representation of an out-of-coverage scenario;

FIG. 3 illustrates an example of a channel access blocking scenario;

FIG. 4 is a schematic representation of a wireless communication system including a transmitter, like a base station, and one or more receivers, like user devices, UEs, implementing embodiments of the present invention;

FIG. 5 illustrates a wireless communication system operating on resources also from an unlicensed spectrum and including user devices and a base station in accordance with embodiments of the present invention;

FIG. 6 illustrates a UE operating in accordance with embodiments of a first aspect of the present invention;

FIG. 7 illustrates a UE operating in accordance with embodiments of a second aspect of the present invention;

FIG. 8(A)-(D) illustrate overbooking approaches in accordance with embodiments of a second aspect of the present invention, wherein FIG. 8(A) illustrates an unlicensed transmission, FIG. 8(B) illustrates a first embodiment of an overbooking approach, FIG. 8(C) illustrates a second embodiment of an overbooking approach, and FIG. 8(D) illustrates a third embodiment of an overbooking approach;

FIG. 9 illustrates a UE operating in accordance with embodiments of a third aspect of the present invention;

FIG. 10 illustrates for a multi-channel LBT with a reduced sensing in accordance with an embodiment of the third aspect of the present invention;

FIG. 11 illustrates a base station operating in accordance with embodiments of a fourth aspect of the present invention;

FIG. 12 illustrates collecting usage statistics of resource usage within an unlicensed spectrum in accordance with an embodiment of the fourth aspect of the present invention;

FIG. 13 illustrates a gNB-assisted coordination for avoiding or resolving LBT blocking in accordance with an embodiment of the fourth aspect of the present invention; and

FIG. 14 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

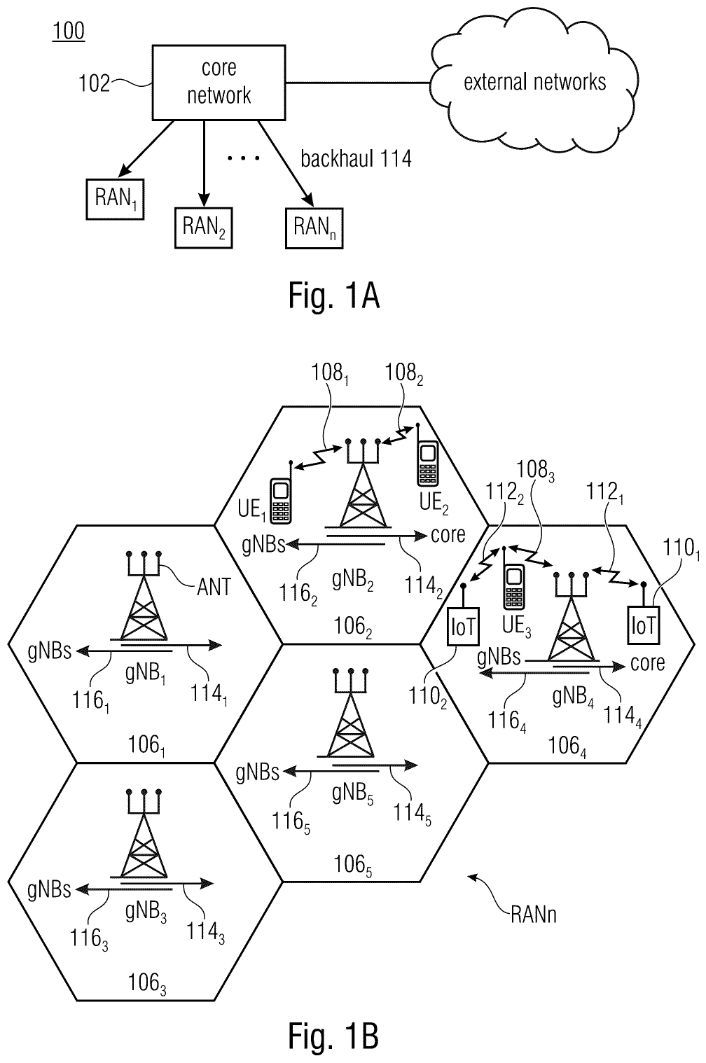

In mobile communication systems or networks, like those described above with reference to FIG. 1, for example in an LTE or 5G/NR network, the respective entities may communicate using one or more frequency bands. A frequency band includes a start frequency, an end frequency and all intermediate frequencies between the start and end frequencies. In other words, the start, end and intermediate frequencies may define a certain bandwidth, e.g., 20 MHz. A frequency band may also be referred to as a carrier or subcarrier, a bandwidth part, BWP, a subband, a subchannel, an interlace, and the like.

When using a single frequency band, the communication may be referred to as a single-band operation, e.g., a UE transmits/receives radio signals to/from another network entity on frequencies being within the band, like the 20 MHz band.

When using a two or more frequency bands, the communication may be referred to as a multi-band or multi-carrier operation or as a wideband operation or as a carrier aggregation operation. The frequency bands may have different bandwidths or the same bandwidth, like 20 MHz. For example, in case of frequency bands having the same bandwidths a UE may transmit/receive radio signals to/from another network entity on frequencies being within two or more of the 20 MHz bands so that the frequency range for the radio communication may be a multiple of 20 MHz. The two or more frequency bands may be continuous/adjacent frequency bands or some or all for the frequency bands may be separated in the frequency domain.

The multi-band operation may include frequency bands in the licensed spectrum, or frequency bands in the unlicensed spectrum, or frequency bands both in the licensed spectrum and in the unlicensed spectrum.

Carrier aggregation, CA, is an example using two or more frequency bands in the licensed spectrum and/or in the unlicensed spectrum. Also mixed combinations are possible, e.g., one or more frequency bands in licensed and one or more frequency bands in unlicensed bands. Furthermore, CA may also be just used for aggregation of an additional carrier in one direction, e.g., as a supplemental carrier to improve transmissions via UL, DL or SL. 5G New Radio (NR) may support an operation in the unlicensed spectrum so that a single-band operation or a multi-band operation may include frequency bands or subbands in the unlicensed spectrum. The unlicensed spectrum may include bands with a potential IEEE 802.11 coexistence, such as frequency bands within the 5 GHz and/or the 6 GHz spectrum. NR-U may support bandwidths that are an integer multiple of 20 MHz, for example due to regulatory requirements. The splitting into the subbands may be performed so as to minimize interference with coexisting systems, like IEE 802.11 systems, which may operate in one or more of the same bands with the same nominal bandwidth channels, like 20 MHz channels. Other examples, of coexisting systems may use subbands having subband sizes and nominal frequencies different from the above-described IEEE 802.11 systems. For example, the unlicensed spectrum may include the 5 GHz band, the 6 GHz band, the 24 GHz band or the 60 GHz band. Examples of such unlicensed bands include the industrial, scientific and medical, ISM, radio bands reserved internationally for the use of radio frequency energy for industrial, scientific and medical purposes other than telecommunications.

During an operation using unlicensed subbands, Listen-before-talk, LBT, may be performed separately per frequency band or subband. This may lead to a situation in which one or more of the frequency bands or subbands are busy or occupied due to an interference, for example, from other communication systems coexisting on the same band, like other public land mobile networks, PLMNs or systems operating in accordance with the IEEE 802.11 specification or operating under the ETSI Broadband Radio Access Networks, BRAN, specifications. In such a situation, the transmitter, either the transmitting gNB or the transmitting UE, is only allowed to transmit on the subbands which are detected to be not busy, also referred to as subbands being free or non-occupied. For example, for a transmission spanning more than 20 MHz in the 5 GHz operational unlicensed band, the transmitter, like the gNB or the UE, performs Listen-Before-Talk, LBT, separately on each subband. Once the LBT results are available for each subband, the devices, for example, the gNB in the downlink, DL, or the UE in the uplink, UL, are allowed to transmit on those subbands which are determined to be free or unoccupied, i.e., to transmit on the won subband(s). No transmission is allowed on the occupied, busy, or non-won subbands.

For accessing resources or channels in the unlicensed spectrum, a so-called NR-U channel access is to be performed, which makes use of a channel access procedure, CAP, which is a procedure based on sensing that evaluates the availability of a channel for performing transmissions. The basic unit for sensing may be a sensing slot with a certain duration, e.g., Tₛₗ=9 μs. The sensing slot duration Tₛₗ is considered to be idle if a base station or a UE senses the channel during the sensing slot duration and determines that the detected power is less than an energy detection threshold for at least a certain time, like 4 μs. within the sensing slot duration. Otherwise, the sensing slot duration is considered to be busy. In case a channel is available or not busy, one or more transmission may be performed on the channel, and the so-called channel occupancy refers to the one or more transmissions on the one or more channels by the base station or UE after performing the corresponding channel access procedure. A channel occupancy time, COT, refers to the total time for which the base station or UE and any other base station or UE may share the channel occupancy to perform one or more transmissions on the channel after the base station or UE has performed the channel access procedure, CAP.

For determining a channel occupancy time, if a transmission gap is less than or equal to a certain period, like 25 μs, the gap duration is counted in the channel occupancy time. A channel occupancy time may be shared for a transmission between a base station and a corresponding UE or between a UE and its corresponding base station. In case of sidelink operation in unlicensed spectrum, SL-U, COT sharing among UEs is allowed with certain constraints.

Several types of channel access procedures, CAPs, may exist, e.g.:
Type-1 CAP The time duration for which the sensed channel has to be idle before the transmission may be random. For example, a base station or a UE may determine an initial counter N which is randomly selected to be between 0 and CWₚ, where CWₘᵢₙ, p≤CWₚ≤CW_{max, p}, with CW_{min, p}\hat{ }CW_{max, p} being subject to the channel access procedure class, CAPC. When the channel is sensed to be idle for a certain period of time, the value of N is decreased, and a transmission may take place only once N reaches 0.
Type-2A: The time duration for which the sensed channel has to be idle before the transmission may be deterministic, and the and the channel may need to be idle for two sensing slots (e.g., at the beginning and end) within a sensing interval of a first duration, like 25 μs.
Type-2B: The time duration for which the sensed channel has to be idle before the transmission may be deterministic, and the channel may need to be idle for one sensing slot within a sensing interval of a second duration shorter than the first duration, like 16 μs.
Type-2C: This type does not perform any sensing of the channel before the transmission, and the duration of a corresponding transmission may have a predefined duration, e.g., may be at most 584 μs. This may also be referred to as an LBT-less CAP.

Once a UE has performed the channel access procedure, CAP, the UE occupies the given band or channel in which it performed the CAP and the COT begins. The UE is also referred to as the initiating UE. It is also possible for the initiating UE to share the COT with another gNB or with another UE, also referred to as the responding UE.

The above described use of resources from the unlicensed spectrum is not limited to a communication between user devices, UEs, and a network entity, like a gNB, over the Uu interface, but is also applicable to a communication over the sidelink among respective UEs, also referred to as sidelink on unlicensed spectrum, SL-U. SL-U is supported for both Mode 1 and Mode 2 where Uu operation for Mode 1 may be limited to the licensed spectrum. SL-U may reuse the channel access mechanisms described above for NR-U. SL-U works similar than other technologies operating in the unlicensed spectrum. Such other technologies operating in the unlicensed spectrum or in unlicensed frequency bands, may be divided into the following groups:
IEEE-based technologies: WiFi, e.g., IEEE 802.11-family, Bluetooth.
3GPP-based technologies: LTE-U, NR-U and successors.
Proprietary technologies, for example, technologies adhering to the general framework defined for medium access of the unlicensed spectrum defined by ETSI CEPT. Typically, access rules define the allowed transmit power, bandwidth and duration of the access. In case of low power devices, a certain frequency hopping scheme may be implemented.

The IEEE-and 3GPP-based technologies mentioned above adhere to strict medium access rules. Moreover, there may be certain frequency bands which are licensed to 3GPP-based technologies only, and in such scenarios 3GPP-based devices, like sidelink user devices, SL-UEs, do not have to coexist with, for example, WiFi devices. This may allow for a more efficient channel access mechanism, for example with the help of a gNB when operating in SL Mode 1, or by sharing a channel occupancy time, COT, among the UEs, without the need of performing an additional sensing or an additional channel access-procedure.

However, the general SL-U channel access procedure may lead to a blocking of a channel access of a device. For example, a SL-U UE may perform a channel access procedure, like an LBT procedure, and senses one or more other devices transmitting during this LBT procedure. In such a case, the UE considers the channel to be occupied, even in case the sensed resources are free at the time of the intended transmission, i.e., the intended transmission is possible but due to an ongoing transmission during the CAP duration, it is judged to be not possible. Therefore, the UE backs off and waits until the wireless medium is free again, to continue with the channel access procedure. This is also referred to as CAP or LBT blocking and may be an issue for high priority data transmission and/or for transmissions containing certain control information and/or certain data.

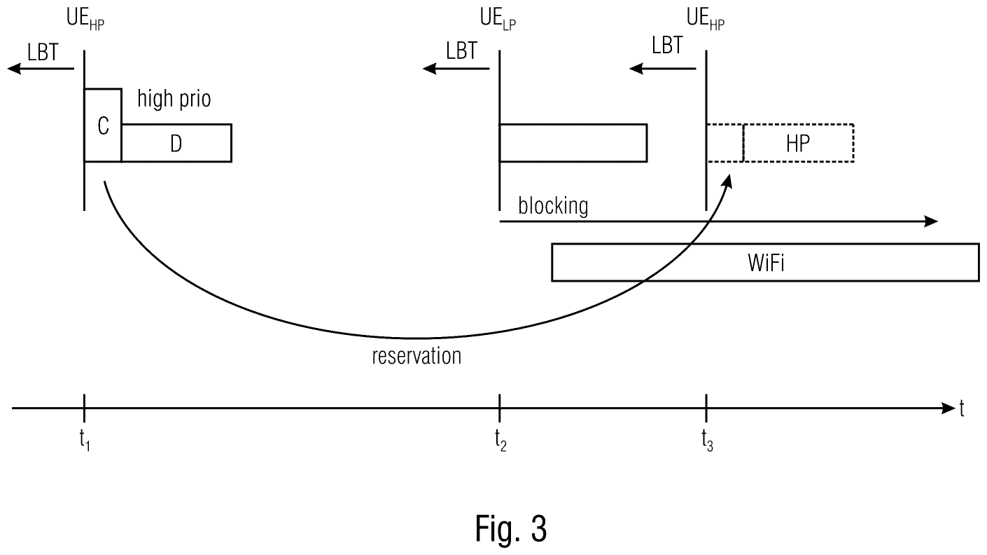

FIG. 3 illustrates an example of a channel access blocking scenario. A UE which intends to perform a high priority, HP, transmission at a time t₁ and also at a later point in time, namely at the time t₃, is referred to as UE_{HP}. Before time t₁, UE_{HP} performs the LBT procedure which determines that the resources defining the channel are available so that at the time t₁, and UE_{HP} performs the high priority transmission which includes control data C and payload data D. In addition, UE_{HP} makes, via the control data C, a reservation for the same resources at the time t₃ for performing a further HP transmission. For performing the further HP transmission at the time t₃, UE_{HP} needs to perform a further LBT procedure prior to the time t ₃. In FIG. 3, it is indicated that there is a further UE, UE_{LP}, which intends to perform at the time t₂ a sidelink transmission on the resources which also UE_{HP} intends to use at the time t₃. UE_{LP} has no knowledge about this intention and, prior to the time t₂ performs its LBT procedure which determines that the resources are available and then, at the time t₂, UE_{LP} transmits its low priority, LP, transmission. The time period between t₂ and t₃ may be such that the LBT procedure performed by UE_{HP} at the time preceding time t₃, at least in part, determines the resources to be occupied by the LP transmission of UE_{LP} so that the resources are determined not to be available for the high priority transmission the UE_{HP} intends to transmit at t3. Thus, despite the fact that the resources were reserved and are actually not used at t3, UE_{HP} does not perform the transmission of its HP transmission as desired. This is referred to as the LBT or CAP blocking issue.

A similar situation arises in case the resources preceding the time t₃ are used by non-3GPP technology devices, like a WiFi device as indicated in the lower part of FIG. 3 which starts a transmission in the time interval between t₂ and t₃ and extending beyond t₃ so that also in such a case the LBT procedure performed by UE_{HP} at the time before t₃ indicates the resources intended for the further high priority transmission to be not available, thereby also blocking access to the desired resources or channel.

When CAP or LBT blocking occurs, data that, originally, is associated with a high priority, like Ultra Reliable Low Latency Communication, URLLC, data, may be delayed to an extent that it is not possible to perform the transmission within the requirements set by the URLLC service. Also, transmissions having a certain content, like certain control information or certain data which are needed to be transmitted at the initially intended time at which the CAP is carried out, may be delayed. Such delays may result in undesired delays at the receiver so that, for example, in case of a high priority transmission as it may be encountered in V2V scenarios, the data may be outdated at the time they finally reach the recipient. Further, control information needed for controlling operation at the recipient may not receive the recipient in time. Thus, the delays introduced due to the CAP or LBT blocking lead to a reduced efficiency of the communication of the unlicensed spectrum. Thereby any advantages achievable by a communication in the unlicensed spectrum may be reduced or even nullified given the potential delays experienced in case of CAP blocking.

Embodiments of the present invention address the above issues by providing approaches resolving a CAP blocking issue where one UE performs a certain CAP for performing its transmission but is blocked by a transmission from another UE that occurs during the CAP. The subsequently described aspects of the present invention are advantageous as the CAP blocking issue is resolved or reduced thereby avoiding undesired delays in the transmission of information, thereby increasing the efficiency of the wireless communication by better exploiting the advantages provided by a communication using resources from the unlicensed spectrum.

### First Aspect

A first aspect of the present invention addresses a situation in which a certain UE intends to submit a certain transmission over the sidelink using resources from the unlicensed spectrum but determines that during its CAP another UE is performing a transmission on the resources on which the CAP is carried out which, conventionally results in the channel access blockage. This situation is avoided as, in accordance with embodiments of the first aspect of the present invention, a UE which is to perform a direct transmission to another UE using the unlicensed spectrum is made aware of resources that are reserved for the certain transmission by the other UE, like a high priority transmission. On the basis of this knowledge, the UE determines to one or more certain actions. For example, the UE may perform a COT sharing, or a COT deferral or it may modify its transmission or it may notify another device, e.g., a base station or RSU or another UE. When performing COT sharing, the UE accesses the channel but allows COT sharing with the other UE which then may use the COT obtained by the UE for transmitting the certain transmission, like the high priority transmission. In case of COT deferral, the UE does not continue to perform a channel access procedure for the occupied or reserved resources but performs a channel access procedure for evaluating other resources so that no CAP blocking is experienced by the other UE when this other UE performs its CAP for performing the high priority transmission. When modifying, the UE may modify its transmission such that it no longer causes the CAP blocking. When the UE is connected to another device, e.g., to a base station or RSU or another UE, it performs the notifying to allow other device to alter an operation of the UE or of another UE for addressing the CAP blocking issue. For example the other device may cause a change in the UE operation, e.g., the network may change the scheduling for causing a COT deferral, COT sharing or COT extension, or gNB may could instruct other UEs to shift or even stop their transmissions, or move to other frequency bands.

### Second Aspect

A second aspect of the present invention, like the first aspect, addresses a situation in which a certain UE intends to submit a certain transmission over the sidelink using resources from the unlicensed spectrum but determines that during its CAP another UE is performing a transmission on the resources on which the CAP is carried out which, conventionally results in the channel access blockage. This situation is avoided as, in accordance with embodiments of the second aspect of the present invention, a UE which has to perform a specific transmission is allowed to use overbooking so that, other than in conventional approaches, for example a plurality of frequency subbands may be probed for available resources by a CAP so that the probability that a CPA blocking is reduced as in case on subband is blocked, another subband may be available for the transmission.

In accordance with embodiments, overbooking may be allowed if one or more predefined criteria are fulfilled so that the overbooking approach is not applied constantly thereby avoiding the unnecessary blockage of resources in a situation where it is not required.

### Third Aspect

A third aspect of the present invention, like the first and second aspects, addresses a situation in which a certain UE intends to submit a certain transmission over the sidelink using resources from the unlicensed spectrum but determines that during its CAP another UE is performing a transmission on the resources on which the CAP is carried out which, conventionally results in the channel access blockage. This situation is avoided as, in accordance with embodiments of the third aspect of the present invention, a UE which has to carry out a certain transmission is allowed to perform a multi-channel access procedure, like a multi-channel LBT. For example, a first CAP is performed for resources that are exclusively used for high priority transmissions and one or more further CAPs are performed for resources other than the first resources thereby providing sufficient bandwidth for transmitting the desired transmission. Note, that the one or more further CAPs may involve performing a shorter LBT procedure on a second frequency resource, and if performed successfully together with a first CAP on a first frequency resource, this enables the UE to access both frequency resources while using less LBT-time than compared to performing two separate LBT procedures on the first and second frequency band individually. Furthermore, this approach is advantageous as it keeps the number of transmissions using the high priority resources below a certain value, for example, below an average resource consumption, so that, as a consequence, also the probability that an access blocking occurs for such transmissions is reduced.

### Fourth Aspect

A fourth aspect of the present invention, like the first, second and third aspects, addresses a situation in which a certain UE intends to submit a certain transmission over the sidelink using resources from the unlicensed spectrum but determines that during its CAP another UE is performing a transmission on the resources on which the CAP is carried out which, conventionally results in the channel access blockage. This situation is avoided, in accordance with embodiments of the fourth aspect of the present invention, the channel access blocking issue is resolved or reduced by involving a network entity into the process of determining resources to be used for a certain transmission by a UE in the unlicensed spectrum. For example, a base station may be provided which determines resources that are reserved for transmissions in the unlicensed spectrum and/or resources that are used by other devices, e.g., non-3GPP technology devices, also located in the vicinity or coverage of the base station. The knowledge of the reserved resources is used by the base station for coordinating with the UEs the resources to be used for the sidelink transmission and, since due to the knowledge provided by the base station, blocked resources are known, the UEs may be controlled so as to avoid performing channel access procedures on such resources thereby reducing or even avoiding channel access blocking.

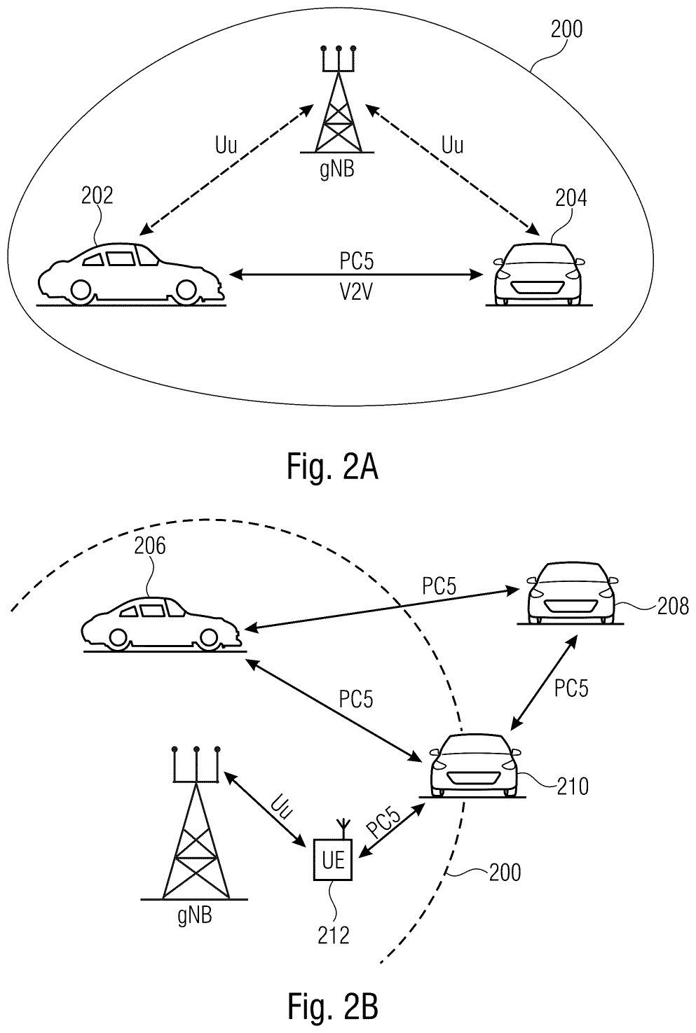

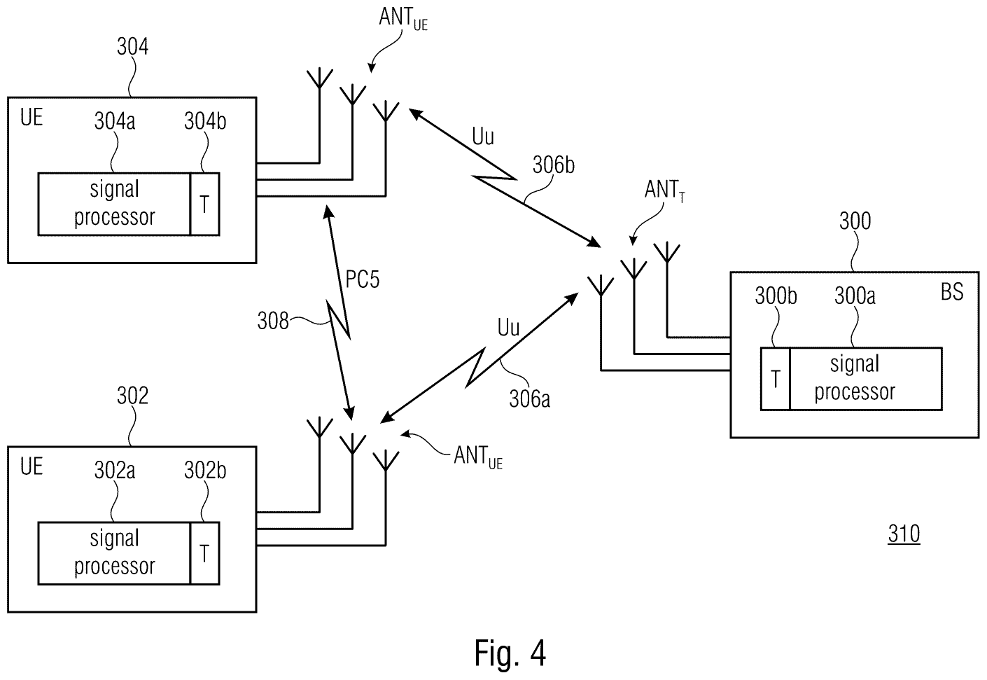

Embodiments of the present invention may be implemented in a wireless communication system as depicted in FIG. 1, FIG. 2(A) or FIG. 2(B) including base stations and users, like mobile terminals or IoT devices. FIG. 4 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANTT or an antenna array having a plurality of antenna elements, a signal processor 300a and a transceiver 300b, coupled with each other. The receivers 302, 304 include one or more antennas ANTUE or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 4, the one or more UEs 302, 304 of FIG. 4, and the base station 300 of FIG. 4 may operate in accordance with the inventive teachings described herein.

### First Aspect

The present invention provides a user device, UE, for a wireless communication network,
wherein the UE is to communicate with one or more further UEs in the wireless communication network using resources in an unlicensed spectrum,
wherein, for a transmission on a first set of resources in the unlicensed spectrum, the UE is to determine whether or not one or more resources of the first set of resources are reserved by a further UE for performing a certain transmission, and
wherein, responsive to determining that one or more resources of the first set of resources are reserved, the UE is to perform an action, the action comprising one or more of the following:
performing COT sharing,
performing COT deferral,
modifying the transmission,
notifying another device, e.g., a base station or RSU or another UE.

In accordance with embodiments,
the wireless communication network is a 3^{rd} Generation Partnership Project, 3GPP, network, and the transmission is over a sidelink, SL, or
the wireless communication network is a non-3GPP network, like a WiFi network.

In accordance with embodiments, COT sharing comprises performing a first channel access procedure, CAP, for evaluating an availability of the first set of resources in the unlicensed spectrum for performing the transmission, and, responsive to a successful first CAP, occupy a channel within a first channel occupancy time, COT, and share the first COT with the further UE.

In accordance with embodiments, wherein COT deferral comprises performing a second channel access procedure, CAP, for evaluating an availability of a second set of resources in the unlicensed spectrum for performing the transmission, and, responsive to a successful second CAP, occupy a channel within a second COT, and perform the transmission within the second COT.

In accordance with embodiments, wherein modifying the transmission comprises one or more of the following:
shortening a COT obtained by the UE and/or a shared COT,
skipping a COT obtained by the UE and/or a shared COT,
ending a COT obtained by the UE and/or a shared COT,
early terminating or skipping of the transmission, e.g., flushing a transmit buffer off the UE,
shifting the transmission to an earlier or later time instance, e.g., performing Discontinuous Reception, DRX, for a certain time,
changing a frequency band and/or a CAP subband and/or an interlace,
changing an operation mode of the UE, e.g., change from mode 2 to mode 1 or vice versa,
performing a CAP and upon a successful first CAP, extending a channel occupancy time of the transmission until prior a time at which a CAP of the further UE is performed, e.g., by
using cyclic prefix extension, CPE, or
a multi-consecutive slot transmission, McST.

In accordance with embodiments, the UE is to notify the other device by signaling of one or more of:
the COT deferral, e.g., that the COT is deferred and/or additional information where the new COT is located, e.g., a Time Resource Indicator Value, TRIV, and/or a Frequency Resource Indicator Value, FRIV, of the deferral,
information on the COT sharing, e.g., that a shared COT is initiated, and/or additional information, e.g., COT sharing parameters, e.g., a COT length, an ID or priority of UE that the COT is shared with,
one or more reserved resources of the first set of resources, e.g., a TRIV and/or a FRIV location and/or an ID and/or priority of the further UE,
the modification of the transmission.

In accordance with embodiments, the second set of resources in the unlicensed spectrum for performing the transmission comprises one or more of:
resources different from the first set of resources,
resources from the first set of resources which are not used by the certain transmission, e.g., resources following resources used by the certain transmission,
shared resources, e.g., resources provided via COT sharing by a further UE, e.g., a UE having a high priority transmission.

In accordance with embodiments, the UE is to perform the action only in case one or more of the following criteria are fulfilled:
the UE is within a certain range, e.g., a minimum required communication range, MCR, of the further UE,
the further UE has a certain UE identification, ID,
a duration or length of the first COT is sufficient for performing the transmission and the certain transmission,
the first set of resources comprises resources for which COT sharing is allowed,
the certain transmission was announced or reserved sufficiently ahead of the transmission,
the certain transmission comprises certain control and/or data, e.g., one or more of:
   a physical sidelink shared channel, PSSCH,
   a physical sidelink control channel, PSCCH,
   a physical sidelink feedback channel, PSFCH,
   an inter-UE coordination, IUC, message or IUC related data, e.g., one or more assistance information messages, AIMs, containing, e.g., a set of preferred or non-preferred resources to be used by another UE,
   a feedback message or feedback data, like an acknowledgement, ACK, and/or a non-acknowledgement, NACK, transmitted on, e.g., a physical sidelink feedback channel, PSFCH,
   channel state information, CSI, feedback, e.g., channel quality information, CQI, a Signal-to-Interference-and-Noise Ratio, SINR, a Signal-to-Noise Ratio SNR, a Radio Signal Strength Indicator, RSSI, or a Reference Signal Received Power, RSRP,
   broadcast or groupcast related messages,
   feedback-free messages,
   synchronization-related messages, e.g., transmitted via a physical sidelink broadcast channel, PSBCH,
   beam-related information, e.g., information for beam management,
   a high-layer marked message, e.g., an emergency message like a Decentralized Environmental Notification Message, DEMN, or a Cooperative Awareness Message, CAM,
   a feedback message related to the Media Access Control, MAC, layer, or the Radio Resource Control, RRC, layer, or the Radio Link Control, RLC, layer, or the Packet Data Convergence Protocol, PDCP, layer,
the certain transmission has a priority higher than the priority of the transmission,
the certain transmission has a priority higher than the priority of the transmission and one or more defined or pre-defined properties, e.g., a duration being at or exceeding a certain threshold, or the priority further being at or exceeding a certain threshold, i.e., being very high,
the transmission has a priority that is below a certain threshold.

In accordance with embodiments, the wireless communication network is 3GPP, network, and the UE decide to perform the action dependent on one or more of the following:
a configuration of the resource pool, RP,
a CBR, e.g., the CBR being below a defined or pre-defined threshold,
whether or not a non-3GPP technology is present at the location of the UE, e.g., based on a geographical area or zone at which the UE is located or based on a channel measurement, e.g., a sensing result,
whether or not an absenceOfAnyOtherTechnology flag is set,
a mode in which the UE is operated, e.g., Mode 1 or Mode 2,
a cast type used by the UE,
a type of the transmission to be performed by the UE.

In accordance with embodiments, the UE is to perform and/or not to perform one or more of the actions dependent on whether or not a non-3GPP technology is present, e.g.,
in case no non-3GPP technology is present, the UE is not to perform COT sharing but only COT deferral, and
in case non-3GPP technology is present, the UE is not to perform COT deferral but only COT sharing.

In accordance with embodiments, in case no non-3GPP technology is present, the UE is to perform the second CAP on
consecutive resources from the first set of resources which are not used by the certain transmission, e.g., resources following resources used by the certain transmission, in case a number of UEs operating on the resources in the unlicensed spectrum is below a certain threshold, or
resources different from the first set of resources, e.g., different frequency and/or time resources, in case the number of UEs operating on the resources in the unlicensed spectrum is at or above the certain threshold.

In accordance with embodiments, when deciding dependent on the mode in which the UE is operated, the UE is to inform the network or perform one or more of the actions independently.

In accordance with embodiments, when deciding dependent on the cast type used by the UE, the UE is to perform or not perform one or more of the actions.

In accordance with embodiments, when deciding dependent on the type of the transmission, the UE is to perform one or more of the actions in case the transmission is a retransmission or is not a retransmission, e.g.,
perform COT sharing in case the transmission is a retransmission, and
perform COT deferral in case the transmission is not a retransmission.

In accordance with embodiments, the UE is to receive from the wireless communication network or from another UE a signaling allowing the UE to select between one or more of the actions, e.g., COT sharing and COT deferral.

In accordance with embodiments, the signaling is provided to the UE dependent on one or more of the following:
a number of certain transmission on the first set of resources exceeds a predefined threshold,
a channel busy ratio, CBR, exceeds a predefined threshold,
a number of transmission on the first set of resources exceeds a predefined threshold,
a number of failed CAPs for the certain transmission exceeds a predefined threshold,
a number of detected transmissions by non-3GPP technology devices exceeds a predefined threshold,
the CBR of non-3GPP technology devices exceeds a predefined threshold.

In accordance with embodiments, when selecting one or more of the actions, e.g., COT sharing or COT deferral, the UE is to receive COT sharing information from another device for a future transmission.

In accordance with embodiments, the certain transmission comprises
a data transmission having a priority exceeding a certain threshold, or
a transmission containing particular control and/or data, e.g., one or more of:
   feedback data, like an acknowledgement, ACK, and/or a non-acknowledgement, NACK, transmitted on, e.g., a physical sidelink feedback channel, PSFCH,
   channel state information, CSI, feedback, e.g., channel quality information, CQI, a Signal-to-Interference-and-Noise Ratio, SINR, a Signal-to-Noise Ratio SNR, a Radio Signal Strength Indicator, RSSI, or a Reference Signal Received Power, RSRP,
   inter-UE coordination, IUC, related data, e.g., one or more assistance information messages, AIMs, containing, e.g., a set of preferred or non-preferred resources to be used by another UE,
   broadcast or groupcast related messages,
   feedback-free messages,
   synchronization-related messages, e.g., transmitted via a physical sidelink broadcast channel, PSBCH,
   beam-related information, e.g., information for beam management,
   a high-layer marked message, e.g., an emergency message like a Decentralized Environmental Notification Message, DEMN, or a Cooperative Awareness Message, CAM,
   a feedback message related to the Media Access Control, MAC, layer, or the Radio Resource Control, RRC, layer, or the Radio Link Control, RLC, layer, or the Packet Data Convergence Protocol, PDCP, layer.

In accordance with embodiments, for determining whether or not one or more of the first set of resources are reserved by the further UE for performing the certain transmission, the UE is to obtain information on the reserved resources
from the wireless communication network, e.g., using AIMs,
by a sensing procedure performed by the UE, like an LBT,
from a received SCI, e.g., a 1st stage SCI and or a 2^{nd} stage SCI,
from a received DCI,
by a signaling from a network entity, e.g., a base station or a road side-unit, RSU,
using an in-device coexistence framework, e.g., an LTE module inside a multi-RAT modem informs a NR module.

The present invention provides a method for operating a user device, UE, for a wireless communication network, wherein the UE is to communicate with one or more further UEs in the wireless communication network using resources in an unlicensed spectrum, the method comprising:

determining, for a transmission on a first set of resources in the unlicensed spectrum, whether or not one or more resources of the first set of resources are reserved by a further UE for performing a certain transmission, and

responsive to determining that one or more resources of the first set of resources are reserved, performing an action, the action comprising one or more of the following:
performing COT sharing,
performing COT deferral,
modifying the transmission,
notifying another device, e.g., a base station or RSU or another UE.

### Second Aspect

The present invention provides a user device, UE, for a wireless communication network,
wherein the UE is to communicate with one or more further UEs in the wireless communication network using resources in an unlicensed spectrum,
wherein, for performing a transmission on resources in the unlicensed spectrum, the UE is to perform overbooking, by reserving one or more sets of resources, and
wherein, responsive to a successful channel access procedure, CAP, the UE is to occupy a channel within a channel occupancy time, COT, and perform the transmission within the COT.

In Accordance With Embodiments,
the set of resources comprises
a first subset needed for performing the CAP, and
a second subset, comprising of the set of resources to be used for a transmission, and
the first subset comprises some, all or more resources in the unlicensed spectrum needed for the CAP to be performed before the transmission.

In accordance with embodiments,
the wireless communication network is a 3^{rd} Generation Partnership Project, 3GPP, network, and the transmission is over a sidelink, SL, or
the wireless communication network is a non-3GPP network, like a WiFi network.

In accordance with embodiments, the UE is to perform overbooking based on one or more criteria, the criteria including one or more of the following:
the UE has associated therewith a priority exceeding a certain threshold,
the transmission has associated therewith a priority exceeding a certain threshold, like an emergency message,
a percentage of the transmissions having a certain priority is below a certain threshold,
an overbooking ratio allowed for the resources is below a certain threshold,
a CBR, e.g., the CBR being below a defined or pre-defined threshold,
whether or not an absenceOfAnyOtherTechnology flag is set,
the UE has a certain UE identification,
the resources comprises resources for which overbooking is allowed,
the transmission comprises certain control and/or data, e.g., one or more of:
   a physical sidelink shared channel, PSSCH,
   a physical sidelink control channel, PSCCH,
   a physical sidelink feedback channel, PSFCH,
   an inter-UE coordination, IUC, message or IUC related data, e.g., one or more assistance information messages, AIMs, containing, e.g., a set of preferred or non-preferred resources to be used by another UE,,
   a feedback message or feedback data, like an acknowledgement, ACK, and/or a non-acknowledgement, NACK, transmitted on, e.g., a physical sidelink feedback channel, PSFCH,
   channel state information, CSI, feedback, e.g., channel quality information, CQI, a Signal-to-Interference-and-Noise Ratio, SINR, a Signal-to-Noise Ratio SNR, a Radio Signal Strength Indicator, RSSI, or a Reference Signal Received Power, RSRP,
   broadcast or groupcast related messages,
   feedback-free messages,
   synchronization-related messages, e.g., transmitted via a physical sidelink broadcast channel, PSBCH,
   beam-related information, e.g., information for beam management,
   a high-layer marked message, e.g., an emergency message like a Decentralized Environmental Notification Message, DEMN, or a Cooperative Awareness Message, CAM,
   a feedback message related to the Media Access Control, MAC, layer, or the Radio Resource Control, RRC, layer, or the Radio Link Control, RLC, layer, or the Packet Data Convergence Protocol, PDCP, layer.

In accordance with embodiments, in case resources which have been overbooked are not used for the CAP and/or transmission, the UE is to share the COT with one or more other network entities of the wireless communication network.

In accordance with embodiments, the UE is to share the COT depending on one or more of the following criteria:
the network entity, e.g., a neighboring UE, is within a certain range from the UE, e.g., within a minimum required communication range, MCR, of the UE, or in the same zone as the UE, or a geographical distance to the UE is below a certain threshold,
the network entity is a previous target UE of a transmission by the UE, the previous target UE being identified, e.g., using a UE identification, UE-ID,
the network entity is a particular device, e.g., a road-side unit, RSU, a base station, gNB, a certain UE,
the network entity comprises a further UE expected to transmit one or more of a particular message, e.g., one or more of:
   a feedback message, e.g., via a physical sidelink feedback channel, PSFCH,
   an inter-UE coordination, IUC, message, e.g., one or more assistance information messages, AIMs, containing, e.g., a set of preferred or non-preferred resources to be used by another UE,
   channel state information, CSI, e.g., channel quality information, CQI, a Signal-to-Interference-and-Noise Ratio, SINR, a Signal-to-Noise Ratio SNR, a Radio Signal Strength Indicator, RSSI, or a Reference Signal Received Power, RSRP,
   beam-related information.

In accordance with embodiments, the UE decides to perform overbooking dependent on one or more of
a configuration of the resource pool, RP,
a CBR, e.g., the CBR being below a defined or pre-defined threshold,
whether or not a non-3GPP technology is present at the location of the UE, e.g., based on a geographical area or zone at which the UE is located or based on a channel measurement, e.g., a sensing result,
whether or not an absenceOfAnyOtherTechnology flag is set,
a mode in which the UE is operated, e.g., Mode 1 or Mode 2,
a cast type used by the UE,
a type of the transmission to be performed by the UE.

In accordance with embodiments,
in case no non-3GPP technology is present, the UE is not to perform overbooking, and
in case non-3GPP technology is present, the UE is to perform overbooking.

In accordance with embodiments, wherein the signaling of the first subset of resources is done by one or more of
an explicit signaling, e.g., using
   a SCI, e.g., a 1^{st}-stage SCI and/or a 2^{nd}-stage SCI,
   a Medium Access Control layer Control Element, MAC CE,
   a Radio Resource Control, RRC, message, e.g., a SL-RRC message,
an implicit signaling depending on one or more of
   a priority of transmission,
   a cast type of transmission,
   a type of transmission,
   a time and/or frequency location of the transmission, e.g., in case there is a certain pre-defined subband/resource pool configured for this transmission,
using an increased bit-size, e.g., 1 additional bit of signaling used in a previous defined control signaling.

The present invention provides a method for operating a user device, UE, for a wireless communication network, wherein the UE is to communicate with one or more further UEs in the wireless communication network using resources in an unlicensed spectrum, the method comprising
for a transmission on resources in the unlicensed spectrum, performing overbooking, by reserving one or more sets of resources, and
responsive to a successful channel access procedure, CAP, occupying a channel within a channel occupancy time, COT, and perform the transmission within the COT.

### Third Aspect

The present invention provides a user device, UE, for a wireless communication network,
wherein the UE is to communicate with one or more further UEs in the wireless communication network using resources in an unlicensed spectrum, wherein one or more first sets of the resources are reserved for high priority transmissions having a priority at or above a certain threshold,
wherein, for performing a high priority transmission on resources in the unlicensed spectrum, the UE is to perform
a first channel access procedure, CAP, for evaluating an availability of resources from the first set of resources, and
a second channel access procedure, CAP, for evaluating an availability of resources from a second set of resources in the unlicensed spectrum, the second set of resources usable for any transmission, and
wherein, responsive to a successful first CAP and a successful second CAP, the UE is to occupy a channel within a channel occupancy time, COT, and perform the transmission within the COT on the resources from the first and/or second sets of resources.

In accordance with embodiments, the UE is to select the resources for its transmission from one of the first and/or second sets of resources based on a criterion.

In accordance with embodiments, the criterion is one or more of
the starting time of the COT, e.g., the UE chooses the earliest available COT,
the duration of the COT, e.g., the length of the COT,
the frequency resource of the COT, e.g., subchannel or subband or interlace, e.g., the UE chooses a frequency is within a certain frequency range, or which is less interfered, or which has a smaller CBR,
the priority of the UEs transmission.

In Accordance With Embodiments,
the wireless communication network is a 3^{rd} Generation Partnership Project, 3GPP, network, and the transmission is over a sidelink, SL, or
the wireless communication network is a non-3GPP network, like a WiFi network.

In accordance with embodiments, the UE is to use resources from the second set of resources if a priority of the transmission is at or below a certain pre-defined threshold.

In accordance with embodiments, the UE is to perform only the second CAP for evaluating the availability of resources from the second set of resources.

In accordance with embodiments,
the first and second CAPs are of the same type, or
the first and second CAPs are of the different type, e.g., the first CAP, like a Type 1 LBT, has a duration longer than the second CAP, like a Type 2 LBT.

In accordance with embodiments, the UE is decide whether the UE is to perform the first and second CAPs on the first and second set of resources, respectively, is dependent on one or more of:
a configuration of the resource pool, RP,
a CBR, e.g., the CBR being below a defined or pre-defined threshold,
whether or not a non-3GPP technology is present at the location of the UE, e.g., based on a geographical area or zone at which the UE is located or based on a channel measurement, e.g., a sensing result,
whether or not an absenceOfAnyOtherTechnology flag is set,
a mode in which the UE is operated, e.g., Mode 1 or Mode 2,
a cast type used by the UE,
a type of the transmission to be performed by the UE.

In accordance with embodiments,
in case no non-3GPP technology is present, the UE is to perform a CAP of the same type for the first and/or second set of resources, and
in case non-3GPP technology is present, the UE is to perform the first and/or second CAPs of different type.

The present invention provides a method for operating a user device, UE, for a wireless communication network, wherein the UE is to communicate with one or more further UEs in the wireless communication network using resources in an unlicensed spectrum, wherein one or more first sets of the resources are reserved for high priority transmissions having a priority at or above a certain threshold, the method comprising:
for performing a high priority transmission on resources in the unlicensed spectrum, performing
a first channel access procedure, CAP, for evaluating an availability of resources from the first set of resources, and
a second channel access procedure, CAP, for evaluating an availability of resources from a second set of resources in the unlicensed spectrum, the second set of resources usable for any transmission, and
responsive to a successful first CAP and a successful second CAP, occupying a channel within a channel occupancy time, COT, and perform the transmission within the COT on the resources from the first and/or second sets of resources.

### First, Second and Third Aspects

In accordance with embodiments, the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, or a mobile terminal, or a stationary terminal, or a cellular IoT-UE, or a SL UE, or a vehicular UE, or a vehicular group leader UE, GL-UE, or a scheduling UE, S-UE, or an IoT or narrowband IoT, NB-IoT, device, or a WiFi device or WiFi station, STA, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

### Fourth Aspect

The present invention provides base station, BS, for a wireless communication network, like a 3^{rd} Generation Partnership Project, 3GPP, network,
wherein the BS is to serve a plurality of user devices, UEs, of the wireless communication network, the UEs communicating over a sidelink, SL, using resources in an unlicensed spectrum,
wherein the BS is to determine
resources in the unlicensed spectrum that are reserved for transmissions by one or more of the UEs, and/or
resources in the unlicensed spectrum that are used by one or more non-3GPP technology devices located in the coverage area of the BS, and wherein the BS is to do one or more of:
signal to one or more of the plurality of UEs the determined resources,
taking into account the determined resources, schedule one or more of the plurality of UEs with resources in the unlicensed spectrum for performing a transmission,
signal particular information about the used resources, like a blocking rate on a set of resources, to one or more of the plurality of UEs, so as to support a UE to make a decision to perform a channel access procedure, CAP, on a certain resource.

In accordance with embodiments, in case a non-3GPP technology presence is indicated, e.g., in case an absenceOfAnyOtherTechnology flag is set to false, the BS is to determine the resources in the unlicensed spectrum that are used by one or more non-3GPP technology devices.

In accordance with embodiments, the BS is to obtain the resources in the unlicensed spectrum that are used by one or more non-3GPP technology devices from one or more of the following:
the one or more UEs served by the BS,
the one or more non-3GPP technology devices,
one or more databases located at the BS, or reachable from a core network, CN, of the wireless communication network, or reachable via the Internet,
a map, e.g., time and/or frequency grid, indicating for each of a plurality of zones or geographical areas the resources in the unlicensed spectrum that are used by one or more non-3GPP technology devices located in the respective zones or geographical areas.

In accordance with embodiments, the database is accessible by a non-3GPP technology device, like a WiFi access point, AP, or a WiFi station, STA, for storing resources in the unlicensed spectrum that are used by the non-3GPP technology device.

In accordance with embodiments, the BS comprises one or more of a macro cell base station, or a small cell base station, or a central unit of a base station, or a distributed unit of a base station, or an Integrated Access and Backhaul, IAB, node, or a road side unit, RSU, or a WiFi access point, AP, or a UE, or a SL UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

The present invention provides a method for operating a base station, BS, for a wireless communication network,, the method comprising:
serving a plurality of user devices, UEs, of the wireless communication network, the UEs communicating over a sidelink, SL, using resources in an unlicensed spectrum,
determining
resources in the unlicensed spectrum that are reserved for transmissions by one or more of the UEs, and/or
resources in the unlicensed spectrum that are used by one or more non-3GPP technology devices located in the coverage area of the BS, and performing one or more of the following:
signaling to one or more of the plurality of UEs the determined resources,
taking into account the determined resources, scheduling one or more of the plurality of UEs with resources in the unlicensed spectrum for performing a transmission,
signaling particular information about the used resources, like a blocking rate on a set of resources, to one or more of the plurality of UEs, so as to support a UE to make a decision to perform a channel access procedure, CAP, on a certain resource.

### First, Second Third and Fourth Aspects

The present invention provides a wireless communication system, like a 3^{rd} Generation Partnership Project, 3GPP, system, comprising a one or more of the inventive user devices, UEs, and/or one or more of the inventive base stations, BSs.

The present invention provides a non-transitory computer program product comprising a computer readable medium storing instructions which, when executed on a computer, perform one or more of the inventive methods.

Embodiments of the various aspects of the present invention are now described in more detail with reference to the accompanying drawing. It is noted that the subsequently outlined and described aspects or embodiments may be combined such that some or all of the aspects/embodiments are implemented within one embodiment. Further, it is noted that the aspects or embodiments are described with reference to a 3^{rd} Generation Partnership Project, 3GPP, network, and transmissions over a sidelink, SL. However, the subsequently described aspects or embodiments may also be applied for non-3GPP networks, like a WiFi network.

In the description given herein, when referring to “sharing of the channel occupancy” this is also referred to as a UE sharing the COT or using a shared COT. This means that the UE may successfully perform a CAP, and then either partially use or not use the COT, and share the remaining COT or the whole COT with another UE. From the perspective of a UE using the shared COT, the UE may use a channel initially occupied by another UE within or during at least a part of the COT that began in response to another UE occupying the channel. Furthermore, the UE occupying the channel not necessarily means that the UE is transmitting data on the COT, but that the given UE successfully performed a CAP for this COT and shares the COT, e.g., by transmitting control information regarding this COT to another UE or set of UEs, which may potentially occupy this COT for a control and/or data transmission.

When referring to “resources”, in this description, a resource is to be understood as comprising one or more of the following:
one or more symbols,
one or more time slots or subframes or frames,
one or more frequencies or carriers or subchannels or group of subchannels,
one or more interlaces,
one or more frequency bands, like unlicensed subbands,
one or more bandwidth parts,
one or more resource pools,
one or more LBT sub-bands,
one or more spatial resources, e.g., using spatial multiplexing.

Furthermore, when referring to “a set of resources”, in this description, a set of resources may contain one or more than one resource, with the definition of a resource as mentioned above. Moreover, it is noted that when referring to a “channel”, in this description, this may refer to a set of the resources as mentioned above. Thus, a “channel” may also refer to a sub-channel, a sub-band, a resource pool or a SL BWP.

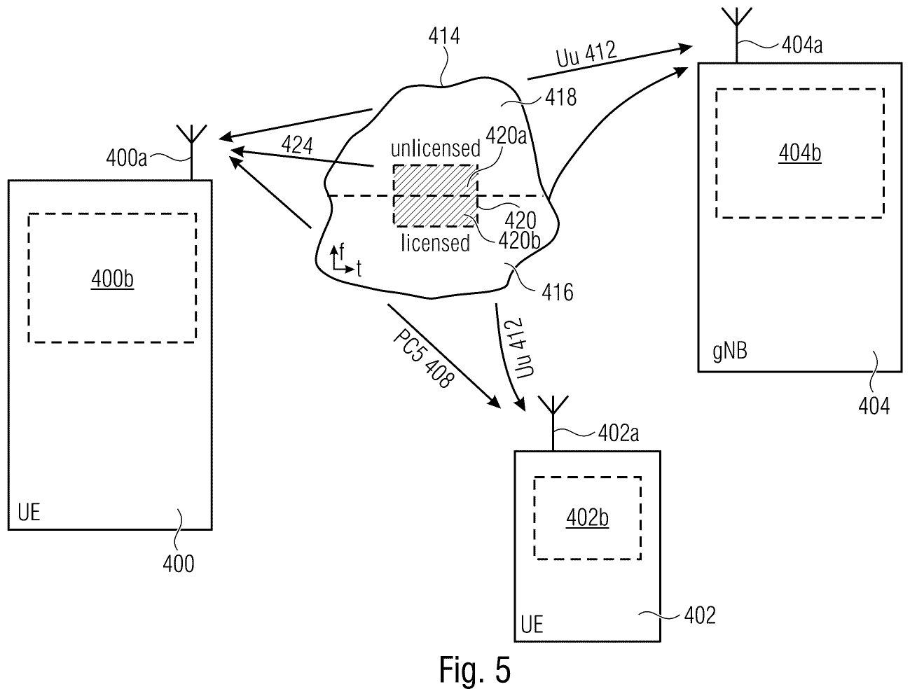

FIG. 5 illustrates a wireless communication system, like the one described above with reference to FIG. 1, FIG. 2 and FIG. 4. The wireless communication system includes user devices 400, 402 and one or more base station 404 operating in accordance with embodiments of the present invention. UE 400, also referred to as sidelink UE, SL-UE, comprises one or more antennas 400a and a signal processor 400b for performing one or more operations, for example operations involving the antenna 400a, like transmitting/receiving data, like payload data or control data, or inter-UE coordination (IUC) messages. UE 400 may communicate with other UEs, like UE 402, using the sidelink or PC5 interface, as is schematically illustrated at 408. UE 402, also referred to as sidelink UE, SL-UE, comprises one or more antennas 402a and a signal processor 402b for performing one or more operations, for example operations involving the antenna 400a, like transmitting/receiving data, like payload data and/or control data, or inter-UE coordination (IUC) messages. Moreover, UE 400 and/or UE 402 may be connected to a base station or gNB 404. The gNB 404 includes one or more antennas 404a for the wireless communication with the other network entities, like UEs 400 and/or 402, and a signal processor 404b. When operating in Mode 1, UE 400 and UE 402 receives via the Uu interface 412 resources allocated by the gNB 404 that are to be used by the UE for the communication over the sidelink 408. As mentioned above, when operating in Mode 2, UE 400 and/or UE 402 may not have a connectivity to the gNB 404 and a sensing plus access resource allocation or a random access-based resource allocation performed prior to performing a transmission.

FIG. 5 further illustrates, schematically, the spectrum 414, like the radio spectrum including the resources to be used for a communication within the wireless communication system or network. The resources available for the SL communication may comprise one or more of the following: one or more symbols, one or more time slots or subframes or frames, one or more resource blocks (RBs) or frequencies or carriers or subchannels or interlaces or group of subchannels, one or more frequency bands. As is further illustrated, schematically, the spectrum 414 comprises the licensed spectrum 416 and the unlicensed spectrum 418. The licensed spectrum 416 is the part of the spectrum that is reserved for the wireless communication system including the UEs 400 and 402 as well as the base station 404. In other words, resources in the licensed spectrum are for exclusive use by this wireless system, as defined by regulatory bodies and entities. The unlicensed spectrum 418 includes resources that may be used by a plurality of wireless communication systems, for example by another wireless communication system in accordance with the 3GPP standard but operated by a different operator, or by systems using a different radio access technology, like WiFi or Bluetooth.

In accordance with embodiments, for the sidelink communication a resource pool 420, also referred to as sidelink resource pool, SL-RP, may be provided, and UE 400 is configured or preconfigured with the resource pool 420. Although the figure depicts only a single resource pool, multiple such resource pools may be configured or preconfigured. Furthermore, the UE may be configured with an exceptional resource pool, which is typically used for handovers. Note that the exceptional resource pool may be treated exactly like a normal resource pool described here. The resource pool may include resources from the unlicensed spectrum 418 only or from the licensed spectrum 416 only, or, as is depicted in the embodiment of FIG. 5, may comprise resources from the licensed spectrum 416 and from the unlicensed spectrum 420. In accordance with further embodiments, the resources in the unlicensed spectrum may be aggregated using carrier aggregation.

### First Aspect

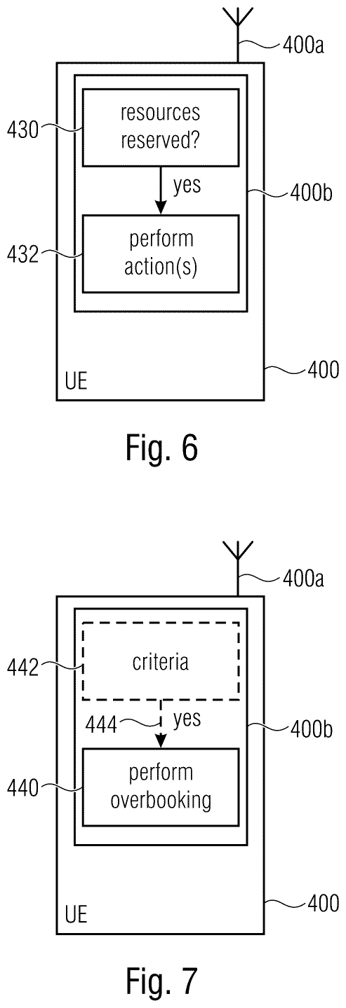

In accordance with embodiments of the first aspect of the present invention, UE 400, which is depicted in FIG. 5, may be configured in a way as schematically represented in FIG. 6 which illustrates a UE 400 operating in accordance with embodiments of the first aspect of the present invention. UE 400 is a sidelink UE, SL-UE, operating at least partially on resources from the unlicensed spectrum. As outlined in more detail above, CAP blocking may be an issue for high priority transmission or for transmissions concerning certain predefined control information and/or data messages. The CAP blocking issue may be experienced for devices which have to perform a channel access Type 1 LBT which is the longest LBT time, for example 54 μs, so that, as depicted and explained above with reference to FIG. 3, due to this long LBT-time, an intended transmission may be interrupted due to another device still operating on the resources in the unlicensed spectrum for which the LBT procedure is carried. As described above with reference to FIG. 3, the device may be another UE or it may be a device operating in accordance with a non-3GPP technology. In either case, a transmission of the other device may have a duration such that the long LBT time indicates the resources to be not available for the intended transmission. Thus, a high priority transmission, i.e., a transmission having a priority exceeding a certain priority level, may be blocked by
(1) another UE performing a transmission of the same priority.
(2) another UE performing a transmission of a lower priority.
(3) a non-3GPP device, like a WiFi device, performing a transmission.

In accordance with embodiments of the first aspect of the present invention, a situation is addressed in which the high priority transmission of one UE is blocked by another UE. Embodiments of the first aspect are directed to the other UE which causes the CAP blocking, which based on a knowledge of reserved resources may adjust its channel access procedures, for example the LBT procedure, so as to avoid blocking a transmission on such reserved resources. It is assumed that UE 400 is a low priority UE performing transmissions having a priority below a certain priority threshold. UE 400, when intending to perform a low priority SL transmission, determines whether the resources to be used for the low priority SL transmission are reserved for a transmission having a higher priority, as is indicated at 430. If it is determined that the resources or at least some of the resources intended for the low priority SL transmission are reserved for a high priority transmission by another UE, UE 400, as is indicated at 432 performs one or more actions. In accordance with embodiments, UE 400 may perform one or more of a COT sharing, a COT deferral, a modification of its low priority transmission, and a notifying of another device, e.g., a base station or RSU or another UE.

In accordance with embodiments, when performing COT sharing, UE 400 is to perform a first channel access procedure, CAP, for evaluating an availability of the resources in the unlicensed spectrum for determining the low priority SL transmission and, responsive to a successful CAP, UE 400 occupies a channel within a first channel occupancy time, COT, and shares the COT with the further UE. Thus, when applying COT sharing, there is no deferral of the LBT procedure by UE 400, but it is allowed that the COT is shared with the other UE. The advantage of the COT sharing approach is that the high priority UE is protected from possible low priority traffic and, in addition, it is protected from potential WiFi transmissions in case the low priority UE, i.e., UE 400, wins the channel occupancy time over the WiFi transmission, and, thus, benefits from less non-3GPP technologies as well as less 3GPP technologies, for example, LTE and/or NR UEs, trying to use the resources simultaneously.

In accordance with embodiments, when performing COT deferral, UE 400 is to perform a second channel access procedure, CAP, for evaluating an availability of a second set of resources in the unlicensed spectrum for performing the low priority SL transmission, and, responsive to a successful second CAP, occupy a channel within a second COT, and perform the SL transmission within the second COT. In other words, when applying COT deferral, the channel access procedure CAP is carried out for evaluating a set of resources which is different from the set of resources reserved for the high priority UE or it may be carried out for resources from the first set of resources but which are not used by the high priority transmission, for example, resources following the high priority transmission. In accordance with further embodiments, the CAP may be performed on shared resources, e.g., resources provided via COT sharing by a further UE, e.g., a UE having a high priority transmission. The COT deferral approach is advantageous as a LBT procedure performed by the high priority UE does not experience interference from UE 400 so that the high priority UE may successfully perform its channel access procedure.

However, non-3GPP technology devices may nevertheless access the channel and still cause a high priority LBT procedure to fail, so that, in case non-3GPP technology devices are indicated to be present, the COT sharing approach may be preferred over the COT deferral approach.

In accordance with embodiments, when performing COT deferral, modifying the low priority transmission by UE 400 may include one or more of the following:
shortening a COT obtained by the UE and/or a shared COT,
skipping a COT obtained by the UE and/or a shared COT,
ending a COT obtained by the UE and/or a shared COT,
early terminating or skipping of the transmission, e.g., flushing a transmit buffer of the UE,
shifting the transmission to an earlier or later time instance, e.g., performing Discontinuous Reception, DRX, for a certain time,
changing a frequency band and/or a CAP subband and/or an interlace,
changing an operation mode of the UE, e.g., change from mode 2 to mode 1 or vice versa,
performing a CAP and upon a successful first CAP, extending a channel occupancy time of the transmission until prior a time at which a CAP of the further UE is performed, e.g., by
   using cyclic prefix extension, CPE, or
   a multi-consecutive slot transmission, McST.
This reduces a probability that a WiFi system accesses the medium. UE 400 may be aware where the high priority UE performs its LBT.

In accordance with embodiments, UE 400 may notify another device in the network by signaling of one or more of:
the COT deferral, e.g., that the COT is deferred and/or additional information where the new COT is located, e.g., a Time Resource Indicator Value, TRIV, and/or a Frequency Resource Indicator Value, FRIV, of the deferral,
information on the COT sharing, e.g., that a shared COT is initiated, and/or additional information, e.g., COT sharing parameters, e.g., a COT length, an ID or priority of UE that the COT is shared with,
one or more reserved resources of the first set of resources, e.g., a TRIV and/or a FRIV location and/or an ID and/or priority of the further UE,
which of the above-mentioned modifications of the low priority transmissions it performed.

In accordance with embodiments, when the UE is connected to another device, e.g., to a base station or RSU or another UE, it performs the notifying. The notifying may indicate that one or more resources of the first set of resources are reserved so that the other device becomes aware of an emerging CAP blocking and is able to take action for altering an operation of the UE or of another UE for addressing the CAP blocking issue. For example, the UE may be a SL UE operating in Mode 1 and the other device is a gNB.

The other device may cause a change in the UE operation, e.g., it may cause UE 400 to perform one or more of the following:
a COT deferral, e.g., that the COT is deferred and/or additional information where the new COT is located, e.g., a Time Resource Indicator Value, TRIV, and/or a Frequency Resource Indicator Value, FRIV, of the deferral,
a COT sharing, e.g., by providing information that a shared COT is initiated, and/or additional information, e.g., COT sharing parameters, e.g., a COT length, an ID or priority of UE that the COT is shared with,
a COT extension, e.g., by signaling one or more reserved resources of the first set of resources that may be used, e.g., a TRIV and/or a FRIV location and/or an ID and/or priority of the further UE,
one or more of the above-mentioned modifications of the low priority transmissions.

In accordance with other embodiments, the notifying may cause the other device to instruct other UEs to shift or even stop their transmissions, or move to other frequency bands.

In accordance with embodiments, UE 400 may operate in accordance with the first aspect of the present invention, i.e., perform one or more of the above referenced actions, only in case one or more of the following criteria are fulfilled:
UE 400 is within a certain range, e.g., a minimum required communication range, MRC, of the high priority UE.
The further UE has a certain UE identification, ID.

For example, the certain ID needs to indicate that the further UE is capable of performing COT sharing. The ID may also indicate that the UE is configured, allowed, or authorized to operate according to the first aspect of the present invention, e.g., to perform COT sharing. In case operation according to the first aspect of the present invention is limited only to a certain group UEs, UE 400 needs to belong to the certain group of UEs.
A duration or length of the first COT is sufficient for performing the low priority transmission and the high priority transmission.
The first set of resources comprises resources for which COT sharing is allowed,
The certain transmission was announced or reserved sufficiently ahead of the transmission.

For example, the high priority UE has announced one or more future transmissions in a previous transmission, e.g., by using an SCI, e.g., by transmitting the periodicity and/or number of future transmission, possibly using the Time Resource Indicator Value, TRIV, and/or a Frequency Resource Indicator Value fields. In accordance with other embodiments, the high priority UE may have indicated future transmissions via an inter-UE coordination, IUC, message or an assistance information message, AIM, in a previous transmission. In accordance with yet other embodiments, the future transmissions may have been announced by the gNB or another UE or another device.
The certain transmission comprises certain control and/or data, e.g., one or more of:
   a physical sidelink shared channel, PSSCH,
   a physical sidelink control channel, PSCCH,
   a physical sidelink feedback channel, PSFCH,
   an inter-UE coordination, IUC, message or IUC related data, e.g., one or more assistance information messages, AIMs, containing, e.g., a set of preferred or non-preferred resources to be used by another UE,
   a feedback message or feedback data, like an acknowledgement, ACK, and/or a non-acknowledgement, NACK, transmitted on, e.g., a physical sidelink feedback channel, PSFCH,
   channel state information, CSI, feedback, e.g., channel quality information, CQI, a Signal-to-Interference-and-Noise Ratio, SINR, a Signal-to-Noise Ratio SNR, a Radio Signal Strength Indicator, RSSI, or a Reference Signal Received Power, RSRP,
   broadcast or groupcast related messages,
   feedback-free messages,
   synchronization-related messages, e.g., transmitted via a physical sidelink broadcast channel, PSBCH,
   beam-related information, e.g., information for beam management, wherein the beam-related information may contain a beam identifier, e.g., a beam ID, or include a beam failure recovery procedure, BFR, including a beam failure detection, BFD, or containing a beam failure indication, BFI or containing a BFR request or response,
   a high-layer marked message, e.g., an emergency message like a Decentralized Environmental Notification Message, DEMN, or a Cooperative Awareness Message, CAM,
   a feedback message related to the Media Access Control, MAC, layer, or the Radio Resource Control, RRC, layer, or the Radio Link Control, RLC, layer, or the Packet Data Convergence Protocol, PDCP, layer.
The certain transmission has a priority higher than the priority of the transmission.
The certain transmission has a priority higher than the priority of the transmission and one or more defined or pre-defined properties, e.g., a duration being at or exceeding a certain threshold, or the priority further being at or exceeding a certain threshold, i.e., being very high.
The transmission has a priority that is below a certain threshold, which allows to reduce signaling or configuration of the UE. The UE may be configured to operate according to the first aspect of the present invention when a transmission to be performed is of a certain priority or less. Thus, there may also be a case where the high priority transmission is not of a high priority enough, for the UE to do COT sharing or deferral or transmission modification because the gap between the priorities of the high priority transmission and the low priority transmission may be needed to have at least a certain value. For example, when the transmission of UE 400 has a low priority, the UE 400 performs COT sharing or deferral or transmission modification for the high priority application. When the transmission of UE 400 has a medium priority, the UE 400 does not perform COT sharing or deferral or transmission modification for the high priority application.

In accordance with further embodiments, UE 400 may operate in accordance with the first aspect of the present invention, i.e., perform one or more of the above referenced actions, dependent on one or more of the following:
A configuration of the resource pool, RP.
For example, an operation according the first aspect of the present invention may be allowed or not allowed for the whole RP or only for one or more parts of the RP.
A channel busy ration, CBR.
For example, an operation according the first aspect of the present invention may be allowed for a CBR being below a defined or pre-defined threshold.
Whether or not a non-3GPP technology is present at the location of the UE, e.g., based on a geographical area or zone at which the UE is located or based on a channel measurement, e.g., a sensing result.
For example, in case no non-3GPP technology is present, the UE is not to perform COT sharing but only COT deferral, and in case non-3GPP technology is present, the UE is not to perform COT deferral but only COT sharing.
For example, in case no non-3GPP technology is present, the UE is to perform the second CAP on consecutive resources from the first set of resources which are not used by the certain transmission, e.g., resources following resources used by the certain transmission, in case a number of UEs operating on the resources in the unlicensed spectrum is below a certain threshold, or on resources different from the first set of resources, e.g., different frequency and/or time resources, in case the number of UEs operating on the resources in the unlicensed spectrum is at or above the certain threshold.
Whether or not an absenceOfAnyOtherTechnology flag is set.
For example, operation according to the first aspect of the present invention may be allowed when a non-3GPP technology, like WiFi or Bluetooth, is not allowed to operate in the same unlicensed spectrum as UE 400. This avoids a situation that despite UE 400 adjusting the channel access procedures or modifying its transmission according to the first aspect of the present invention, a CAP of the high priority UE is still blocked due to a transmission by a non-3GPP technology device.
A mode in which the UE is operated, e.g., Mode 1 or Mode 2, to inform the network or perform one or more of the actions independently.
A cast type used by the UE.
For example, UE 400 may decide to perform a COT sharing for a groupcast transmissions and not for a unicast transmission, since it might sense that groupcast transmissions are of higher importance, e.g., it might reach more UEs with its intended message.
A type of the transmission to be performed by the UE.
For example, UE 400 may perform one or more of the actions in case the transmission is a retransmission or is not a retransmission, e.g., it may perform COT sharing in case the transmission is a retransmission, and COT deferral in case the transmission is not a retransmission.

In accordance with further embodiments, UE 400 may be using one of the actions only when receiving a signaling from the wireless communication network or from another UE, e.g., a coordinating UE, to operate accordingly. For example:
UE 400 is to receive from the wireless communication network or from another UE a signaling allowing UE 400 to select between one or more of the actions, e.g., COT sharing and COT deferral.
The signaling may be provided to UE 400 dependent on one or more of the following:
   A number of certain transmissions on the first set of resources exceeds a predefined threshold,
   a channel busy ratio, CBR, exceeds a predefined threshold,
   a number of transmissions on the first set of resources exceeds a predefined threshold,
   a number of failed CAPs for the certain transmission exceeds a predefined threshold,
   a number of detected transmissions by non-3GPP technology devices exceeds a predefined threshold,
   the CBR of non-3GPP technology devices exceeds a predefined threshold.

In accordance with yet further embodiments, when operating so as to decide to operate in accordance with the first aspect of the present invention, UE 400 may be provided with an incentive. For example, a base station or another UE, like the high priority UE, may provide COT sharing information for a future transmission so that for this future transmission additional LBT procedures are not needed, rather, the UE 400, having assisted the high priority UE, for example, may share or use a COT obtained by the high priority UE for the future transmission.

The embodiments above have been described with reference a high priority transmission for which CAP blocking is to be addressed. However, the first aspect of the present invention may be used also for other transmissions, like a transmission containing particular control and/or data, e.g., one or more of:
feedback data, like an acknowledgement, ACK, and/or a non-acknowledgement, NACK, transmitted on, e.g., a physical sidelink feedback channel, PSFCH,
channel state information, CSI, feedback, e.g., channel quality information, CQI, a Signal-to-Interference-and-Noise Ratio, SINR, a Signal-to-Noise Ratio SNR, a Radio Signal Strength Indicator, RSSI, or a Reference Signal Received Power, RSRP,
inter-UE coordination, IUC, related data, e.g., one or more assistance information messages, AIMs, containing, e.g., a set of preferred or non-preferred resources to be used by another UE,
broadcast or groupcast related messages,
feedback-free messages,
synchronization-related messages, e.g., transmitted via a physical sidelink broadcast channel, PSBCH,
beam-related information, e.g., information for beam management,
a high-layer marked message, e.g., an emergency message like a Decentralized Environmental Notification Message, DEMN, or a Cooperative Awareness Message, CAM,
a feedback message related to the Media Access Control, MAC, layer, or the Radio Resource Control, RRC, layer, or the Radio Link Control, RLC, layer, or the Packet Data Convergence Protocol, PDCP, layer.

In accordance with embodiments, UE 400 obtains information on the reserved resources
from the wireless communication network, e.g., using AIMs,
by a sensing procedure performed by the IE, like an LBT,
from a received SCI, e.g., a 1^{st} stage SCI and or a 2^{nd} stage SCI,
from a received DCI,
by a signaling from a network entity, e.g., a base station or a road side-unit, RSU,
using an in-device coexistence framework, e.g., an LTE module inside a multi-RAT modem informs a NR module.

### Second Aspect

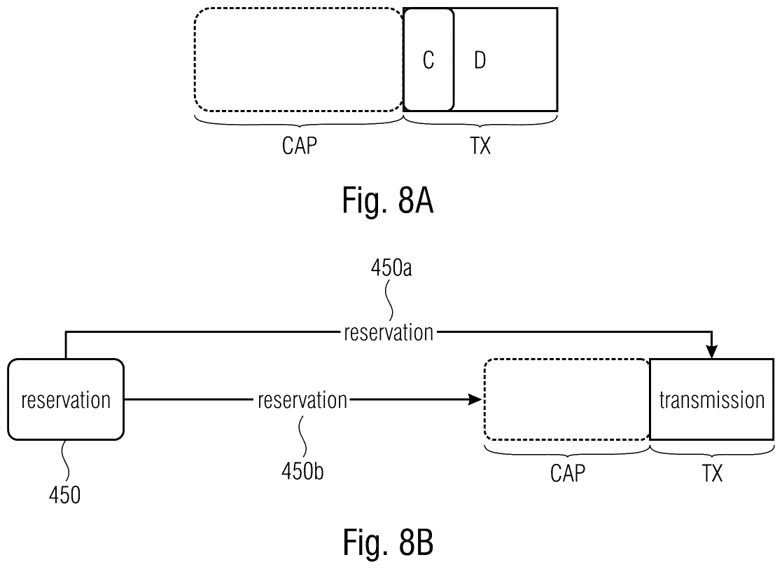

In accordance with embodiments of the second aspect of the present invention, UE 400, which is depicted in FIG. 5, may be configured in a way as schematically represented in FIG. 7 which illustrates a UE 400 operating in accordance with embodiments of the second aspect of the present invention. In accordance with the second aspect, a user device operating on resources of the unlicensed spectrum for performing a sidelink communication, like UE 400, may apply overbooking as is schematically illustrated at 440.

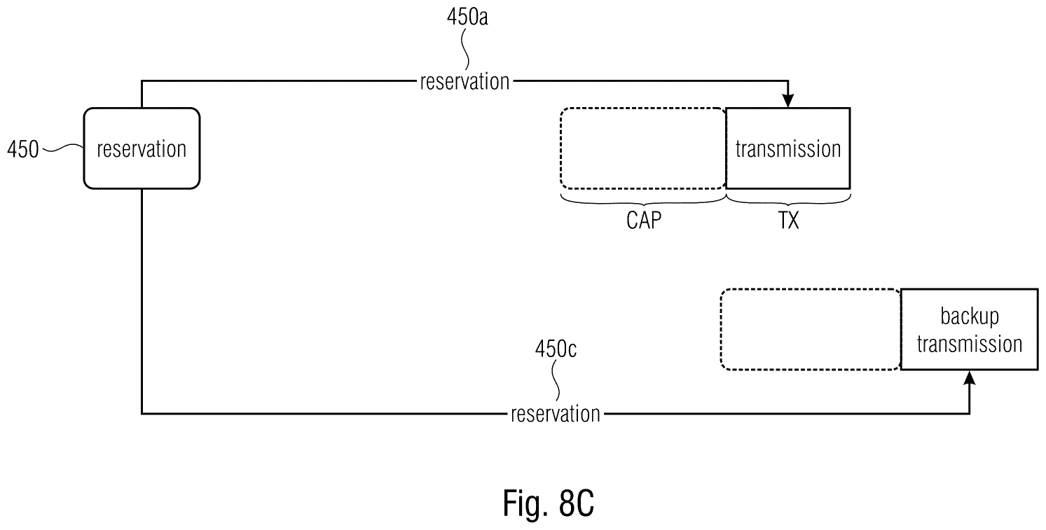

With reference to FIG. 8 embodiments of overbooking approaches that may be performed by UE 400 are described. FIG. 8(A) illustrates an unlicensed transmission. As is shown, the unlicensed transmission TX includes a control signaling C and a data D signaling. Before the transmission a listen-before-talk, LBT, channel access procedure, CAP, is performed.

FIG. 8(B) illustrates a first embodiment of an overbooking approach. In this embodiment a reservation 450 does not only reserve the resources for the intended transmission TX as indicated at 450a but also the resources needed to perform the CAP in which the transmitter does not transmit but performs e.g., LBT, as indicated at 450b. If successful, the transmitter may perform CPE to acquire and keep the COT until the transmission starts.

FIG. 8(C) illustrates a second embodiment of an overbooking approach. In this embodiment a reservation 450 does not only reserve the resources for the intended transmission TX as indicated at 450a but also the resources for an additional backup transmission in case the CAP for the intended transmission TX fails, as indicated at 450c.

FIG. 8(D) illustrates a third embodiment of an overbooking approach. In this embodiment a reservation 450 does not only reserve the resources for the intended transmission TX as indicated at 450a but also the resources needed to perform the CAP in which the transmitter does not transmit but performs e.g., LBT, as indicated at 450b, as well as the resources for an additional backup transmission in case the CAP for the intended transmission TX fails, as indicated at 450c. In accordance with yet further embodiments, the reservation 450 may also reserve the resources needed to perform the CAP for the Backup Transmission in which the transmitter does not transmit but performs e.g., LBT, as indicated at 450d.

In accordance with embodiments, for avoiding channel access failures, like the LBT failure described above with reference to FIG. 3, additional resources may be selected for the transmission. UE 400 may be the above-described high priority UE which intends to perform a high priority transmission and that may experience a LBT failure due to the Type 1 LBT procedure.

Optionally, in accordance with embodiments, the high priority UE, when intending to perform a high priority transmission, may, as is indicated at 442 in FIG. 7, determine whether one or more predefined criteria are fulfilled, and, if this is the case, as is indicated at 444, UE 400 applies overbooking 440. For example, the set of resources includes a first subset needed for performing the CAP, and a second subset inducing the set of resources to be used for a transmission. The first subset comprises some, all or more resources in the unlicensed spectrum needed for the CAP to be performed before the transmission. The signaling of the first subset of resources is done by one or more of
an explicit signaling, e.g., using
   a SCI, e.g., a 1^{st}-stage SCI and/or a 2^{nd}-stage SCI,
   a Medium Access Control layer Control Element, MAC CE,
   a Radio Resource Control, RRC, message, e.g., a SL-RRC message,
an implicit signaling depending on one or more of
   a priority of transmission,
   a cast type of transmission,
   a type of transmission,
   a time and/or frequency location of the transmission, e.g., in case there is a certain pre-defined subband/resource pool configured for this transmission,
using an increased bit-size, e.g., 1 additional bit of signaling used in a previous defined control signaling.

The overbooking of resources means that more resources than needed for the transmission are sensed, e.g., using an LBT of a certain type. For example, UE 400, when performing overbooking, may perform a CAP to evaluate the availability of a plurality of different sets of resources in an unlicensed spectrum for performing its high priority transmission or any other kind of transmission for which an access blocking is to be avoided.

When applying overbooking without considering any criteria, a congestion of the radio channel may be obtained due to the additional resources reserved for one UE. To avoid congestion, in accordance with embodiments of the present invention, overbooking is only allowed when one or more predefined criteria are met:
The UE has associated therewith a priority exceeding a certain threshold.
The transmission has associated therewith a priority exceeding a certain threshold, like an emergency message.
A percentage of the transmissions having a certain priority is below a certain threshold.
An overbooking ratio allowed for the resources is below a certain threshold.
Depending on a CBR, for example, this operation may be allowed for a CBR being below a defined or pre-defined threshold.
The UE has a certain UE identification.
For example, the certain ID needs to indicate that the further UE is capable of performing overbooking. The ID may also indicate that the UE is allowed or authorized to perform overbooking. In case overbooking is limited only to a certain group UEs, UE 400 needs to belong to the certain group of UEs.
The resources comprise of resources for which overbooking is allowed.
The transmission comprises certain control and/or data, e.g., one or more of:
   a physical sidelink shared channel, PSSCH,
   a physical sidelink control channel, PSCCH,
   a physical sidelink feedback channel, PSFCH,
   an inter-UE coordination, IUC, message or IUC related data, e.g., one or more assistance information messages, AIMs, containing, e.g., a set of preferred or non-preferred resources to be used by another UE,
   a feedback message or feedback data, like an acknowledgement, ACK, and/or a non-acknowledgement, NACK, transmitted on, e.g., a physical sidelink feedback channel, PSFCH,
   channel state information, CSI, feedback, e.g., channel quality information, CQI, a Signal-to-Interference-and-Noise Ratio, SINR, a Signal-to-Noise Ratio SNR, a Radio Signal Strength Indicator, RSSI, or a Reference Signal Received Power, RSRP,
   broadcast or groupcast related messages,
   feedback-free messages,
   synchronization-related messages, e.g., transmitted via a physical sidelink broadcast channel, PSBCH,
   beam-related information, e.g., information for beam management,
   a high-layer marked message, e.g., an emergency message like a Decentralized Environmental Notification Message, DEMN, or a Cooperative Awareness Message, CAM,
   a feedback message related to the Media Access Control, MAC, layer, or the Radio Resource Control, RRC, layer, or the Radio Link Control, RLC, layer, or the Packet Data Convergence Protocol, PDCP, layer.

In case resources which have been overbooked are not used for the CAP and/or transmission, UE 400 may share the COT with one or more other network entities of the wireless communication network. The UE may share the COT depending on one or more of the following criteria:
The network entity, e.g., a neighboring UE, is within a certain range from the UE, e.g., within a minimum required communication range, MRC, of the UE, or in the same zone as the UE, or a geographical distance to the UE is below a certain threshold.
The network entity is a previous target UE of a transmission by the UE, the previous target UE being identified, e.g., using a UE identification, UE-ID.
The network entity is a particular device, e.g., a road-side unit, RSU, a base station, gNB, a certain UE.
The network entity comprises a further UE expected to transmit one or more of a particular message, e.g., one or more of:
   a feedback message, e.g., via a physical sidelink feedback channel, PSFCH,
   an inter-UE coordination, IUC, message, e.g., one or more assistance information messages, AIMs, containing, e.g., a set of preferred or non-preferred resources to be used by another UE,
   channel state information, CSI, e.g., channel quality information, CQI, a Signal-to-Interference-and-Noise Ratio, SINR, a Signal-to-Noise Ratio SNR, a Radio Signal Strength Indicator, RSSI, or a Reference Signal Received Power, RSRP,
   beam-related information, e.g., a beam indication, ID, e.g., as part of initial beam pairing, or a beam failure recovery, BFR, indication, e.g., a BFR request or response.

UE 400 may decide to perform overbooking dependent on one or more of
A configuration of the resource pool, RP.
For example, overbooking may be allowed or nor allowed for the whole RP or only for one or more parts of the RP.
A channel busy ration, CBR.
For example, overbooking may be allowed for a CBR being below a defined or pre-defined threshold.
Whether or not a non-3GPP technology is present at the location of the UE, e.g., based on a geographical area or zone at which the UE is located or based on a channel measurement, e.g., a sensing result.
For example, in case no non-3GPP technology is present, the UE is not to perform overbooking, and in case non-3GPP technology is present, the UE is to perform overbooking.
Whether or not an absenceOfAnyOtherTechnology flag is set.
For example, operation according the first aspect of the present invention may be allowed when a non-3GPP technology, like WiFi or Bluetooth, is not allowed to operate in the same unlicensed spectrum as UE 400. This avoids a situation that despite UE 400 applying overbooking, a CAP of the high priority UE is still blocked due to a transmission by a non-3GPP technology device.
A mode in which the UE is operated, e.g., Mode 1 or Mode 2, to inform the network or perform overbooking independently.
A cast type used by the UE.
For example, UE 400 may decide to perform overbooking for a groupcast transmissions and not for a unicast transmission, since it might sense that groupcast transmissions are of higher importance, e.g., it might reach more UEs with its intended message.
A type of the transmission to be performed by the UE.
For example, UE 400 may perform overbooking in case the transmission is a retransmission.
Beam-related aspects: In case the network devices, e.g., UEs, use orthogonal beams pointing in different directions, which may be related to high frequency bands, e.g., FR2, and transmissions might be free of inter-beam interference even when transmitting on the same time/frequency resources. Thus, overbooking of resources may be used more effectively in the spatial domain, e.g., using orthogonal beams.

### Third Aspect

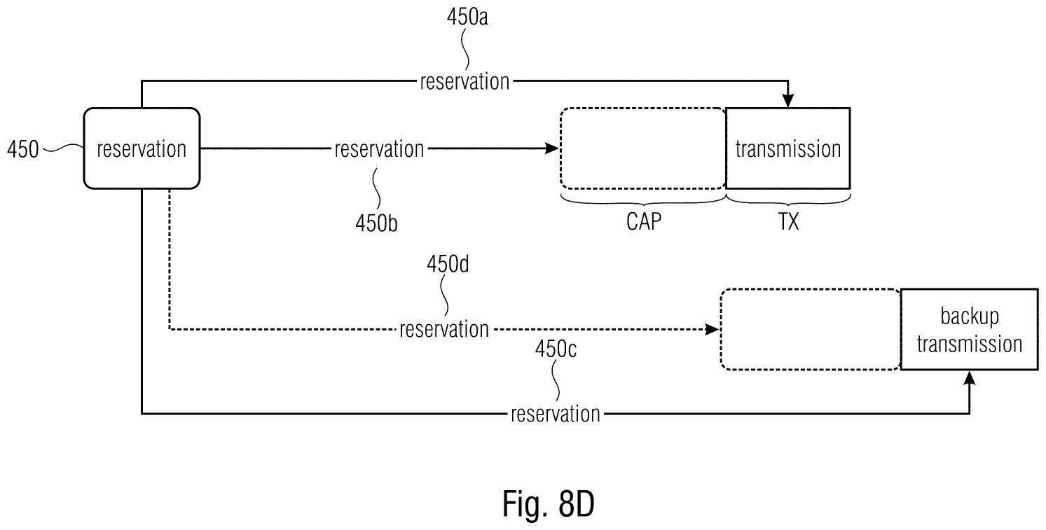

In accordance with embodiments of the third aspect of the present invention, UE 400, which is depicted in FIG. 5, may be configured in a way as schematically represented in FIG. 9 which illustrates a UE 400 operating in accordance with embodiments of the third aspect of the present invention. In accordance with the third aspect, a multi-channel access approach may be applied, also referred to as multi-channel LBT. To make sure that a UE, like a high priority UE, has sufficient resources for performing a desired transmission, like a high priority transmission, in accordance with embodiments of the third aspect, the SL-U UE, like UE 400 in FIG. 5, performs a multi-channel access procedure, as indicated in FIG. 9 at 460.

In accordance with the multi-channel access procedure, a first channel access procedure is carried out for evaluating an availability of resources from a first set of resources which are reserved for a certain transmission, like a high priority transmission. At least one further CAP is performed for evaluating the availability of resources from another set of resources which may be used for any transmission. Responsive to the successful CAPs, the SL transmission is performed using the respective resources.

In another embodiment, the UE may choose to perform more than one CAP, e.g., five CAPs, and even if it has successfully performed all five CAPs, e.g., successful LBTs on all five time/frequency resources, the said UE may choose to use only a certain number of COTs being smaller than the number of CAPs, e.g., three out of five, for its transmission. This may be based on a criterion, e.g., based on the starting time of a COT and/or the exact duration of a COT, and/or the frequency resource of a COT, and/or the priority of the transmission itself.

Thus, in accordance with embodiments, the UE 400 may be configured or preconfigured, for example by a specification or a resource pool configuration, with resources that are reserved for high priority transmissions, i.e., having a priority level associated therewith, which exceeds a certain threshold. The resources may span over a subset of the resource pool in terms of timeslots and/or sub-channels. The high priority transmission may take place on the high priority resources, but is not limited to them. The UE 400 may use the high priority and remaining resources together for a larger transmission, so that sufficient resources are available for completing the high priority transmission.

In case of transmission spanning also resources intended for low priority transmissions, the UE may perform the long LBT only on the resources intended for high priority transmissions while on the resources intended for low priority transmissions, only a short LBT is performed immediately before the transmission, for example a Type 2 LBT procedure. In this way, the number of transmissions on resources intended for high priority transmissions is kept below the average resource consumption so that the possibility of LBT blockage is reduced.

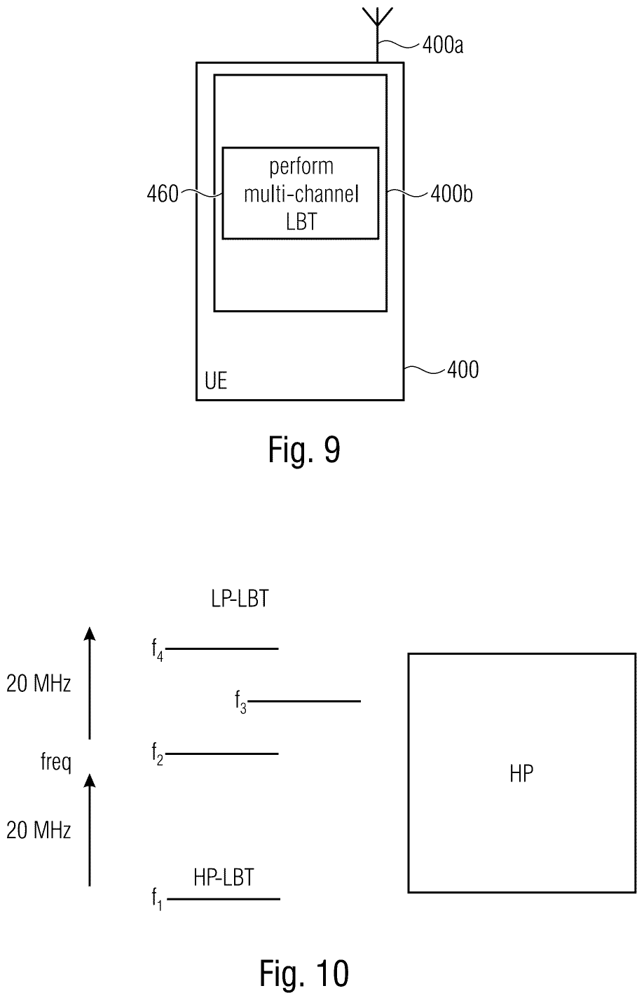

FIG. 10 illustrates an embodiment for a multi-channel LBT with a reduced sensing. The resources available for the sidelink transmission in the unlicensed spectrum are illustrated as two subbands, each spanning a bandwidth of 20 MHz, with the lower subband being reserved for high priority transmissions while the upper subband may be used by any kind of transmission. For performing a high priority transmission HP on resources, both in the high priority subband and in the non-high priority subband, the UE performs in the depicted embodiment respective LBT procedures on four frequencies f₁ to f₄. The first LBT procedure, HP-LBT, is performed for the resources as frequency f₁ in the high priority band while for the other three frequency resources f₂ to f₄ the short access procedures LP-LBT are performed, thereby providing sufficient bandwidths for the transmission of the high priority transmission HP while avoiding the need for carrying out four HP-LBTs in the high priority frequency band, thereby reducing, as mentioned above, the average resource consumption in the high priority band, while still providing sufficient bandwidths for the HP transmission. In accordance with embodiments, UE 400 may use resources from the second set of resources if a priority of the transmission is at or below a certain pre-defined threshold.

400 UE performs only the second CAP for evaluating the availability of resources from the second set of resources.

In accordance with embodiments, the first and second CAPs are of the same type, or the first and second CAPs are of the different type, e.g., the first CAP, like a Type 1 LBT, has a duration longer than the second CAP, like a Type 2 LBT.

UE 400 may decide to perform a multi-channel LBT dependent on one or more of
A configuration of the resource pool, RP.
For example, a multi-channel LBT may be allowed or nor allowed for the whole RP or only for one or more parts of the RP.
A channel busy ration, CBR.
For example, a multi-channel LBT may be allowed for a CBR being below a defined or pre-defined threshold.
Whether or not a non-3GPP technology is present at the location of the UE, e.g., based on a geographical area or zone at which the UE is located or based on a channel measurement, e.g., a sensing result.
For example, in case no non-3GPP technology is present, the UE is to perform a CAP of the same type for the first and second set of resources, and, in case non-3GPP technology is present, the UE is to perform the first and second CAPs of a different type.
Whether or not an absenceOfAnyOtherTechnology flag is set.
For example, operation according the first aspect of the present invention may be allowed when a non-3GPP technology, like WiFi or Bluetooth, is not allowed to operate in the same unlicensed spectrum as UE 400. This avoids a situation that despite UE 400 applying a multi-channel LBT, a CAP of the high priority UE is still blocked due to a transmission by a non-3GPP technology device.
A mode in which the UE is operated, e.g., Mode 1 or Mode 2, to inform the network or perform a multi-channel LBT independently.
A cast type used by the UE.
For example, UE 400 may decide to perform a multi-channel LBT for a groupcast transmissions and not for a unicast transmission, since it might sense that groupcast transmissions are of higher importance, e.g., it might reach more UEs with its intended message.
A type of the transmission to be performed by the UE.
For example, UE 400 may perform a multi-channel LBT in case the transmission is a retransmission.

### Fourth Aspect

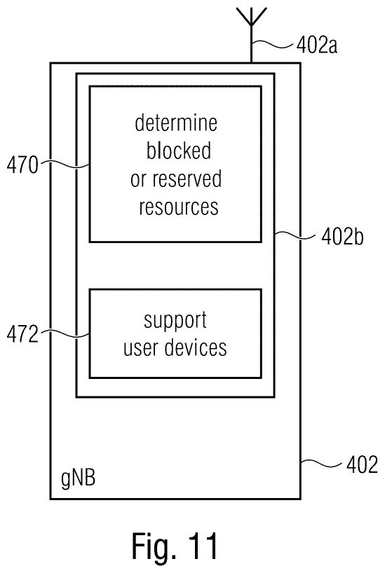

In accordance with embodiments of the fourth aspect of the present invention, base station 402, which is depicted in FIG. 5, may be configured in a way as schematically represented in FIG. 11 which illustrates a base station 402 operating in accordance with embodiments of the fourth aspect of the present invention. In accordance with embodiments of the fourth aspect of the present invention, the channel access blocking issue may be resolved by providing support from a network entity, like a base station. The base station 402 of FIG. 5, in accordance with embodiments, may determine resources in the unlicensed spectrum that are reserved for transmissions by one or more of the sidelink UEs and/or resources that may be used by non-3GPP technology devices located in the vicinity of the base station 402. In FIG. 11, this is illustrated schematically at 470 and, as described above, the base station determines blocked or non-available resources. On the basis of the knowledge of the blocked or unavailable resources, the base station 402, as is indicated at 472, supports the SL-U UEs within its coverage for determining resources on which an LBT or CAP is to be performed. For example, the base station 402 may signal to the UEs the determined resources so as to allow the UE to determine those resources on which an LBT or CAP is to be performed and those which are not suited for performing such a procedure. In addition or alternatively, the base station 402 may support UEs operating in mode 1 and, taking into account the determined resources, the base station may schedule the UEs with the resources in the unlicensed spectrum for performing an SL transmission, i.e., based on the knowledge which resources are blocked or non-available, only those resources which are not reserved or not blocked are scheduled to the UEs so that an LBT procedure may be reliably preformed, i.e., any CAP blocking is avoided. The base station may also signal specific information about the used resources, like a blocking rate on the resources so as to support the UE to make a decision whether a CAP is to be performed on a certain resource or not. For example, in case a certain band has a high number of blocked resources, a UE receiving this information may decide to perform an LBT procedure or other CAP on a different band having a lower rate of occupied or unavailable resources thereby reducing the potential of an LBT blocking.

In accordance with embodiments, dependent on the presence or absence of non-3GPP technology devices, the base station may coordinate resources among the SL-U UEs dependent on one or more of the following:
A priority of the transmissions of the UE, e.g., in case a WiFi system is present in the said resource pool, the base station might only coordinate resources for resolving channel blocking issues for a certain traffic type having a priority equal or above a pre-defined threshold. If no WiFi system is present, the base station may also do the above for medium and high-priority transmission.
The CBR is above a predefined threshold.
The type of resource pool, e.g., the base station only resolves LBT blocking in normal resource pools and not in exceptional resource pool, or vice versa.
Location of the UE. The base station might only coordinate resources in case the UE is within its vicinity, where it is aware if a WiFi system is operating. Alternatively, if the base station is aware of location-based WiFi maps, it may only use this feature dependent on its knowledge whether a WiFi system is active in a certain location, e.g., geo-location or zone, of a UE or not. Furthermore, in case of a multi-RAT base station, the base station might already include a WiFi modem and thus might only perform this action based on the reachability of the WiFi system.
Distance to the UE. Like the above, in case the UE is located too far from the base station, e.g., on the cell-edge, the base station may refrain from coordinating resources to resolve the non-blocking issue, since it might not have enough knowledge on the presents of other UEs or WiFi devices within the vicinity of the said UE.

Thus, in accordance with embodiments of the fourth aspect, in case the absenceOfAnyOtherTechnology flag is present and set to false, the base station or gNB 402 may coordinate the usage of the resources since it may be aware of the usage by a WiFi system which is in the vicinity of the gNB or in the vicinity of a UE. The base station 402 may collect WiFi usage data from other UEs or from the WiFi system itself. In accordance with other embodiments, also a coordinating UE may collect WiFi statistics for assisting other UEs so that LBT blocking may be reduced. For example, the base station may obtain the resources in the unlicensed spectrum that are used by one or more non-3GPP technology devices from one or more of the following:
the one or more UEs served by the BS,
the one or more non-3GPP technology devices,
one or more databases located at the BS, or reachable from a core network, CN, of the wireless communication network, or reachable via the Internet,
a map, e.g., time and/or frequency grid, indicating for each of a plurality of zones or geographical areas the resources in the unlicensed spectrum that are used by one or more non-3GPP technology devices located in the respective zones or geographical areas.

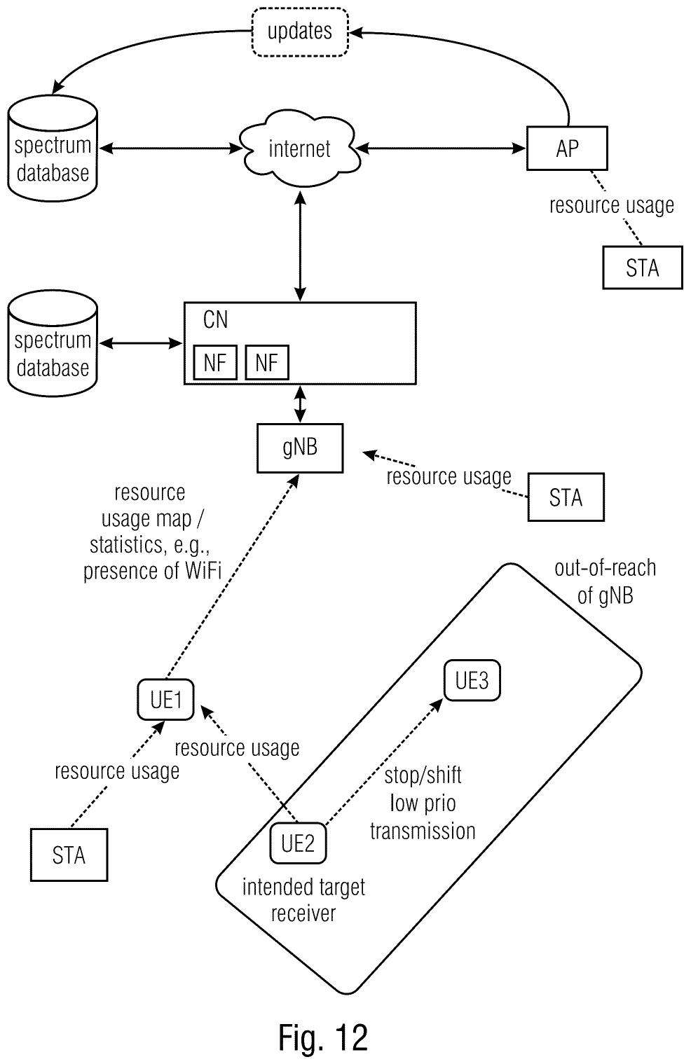

FIG. 12 illustrates an embodiment for collecting usage statistics of resource usage within an unlicensed spectrum. The resource usage data may be collected directly or indirectly, for example, via another UE or via another network node. As is depicted in FIG. 12, the wireless communication network includes the core network CN, implementing the respective network functions as well as the RAN including base station or gNB. Further, the user devices, UE1 to UE3 are illustrated in FIG. 12 among which UE1 is connected via the Uu interface to the gNB while UE2 and UE3, which may be out of reach of the gNB, are connected to the gNB via the PC5 interface between UE1 and UE 2. Over the respective connections, the respective UEs may provide information on resource usage to the gNB. Further, via the respective UEs or via the gNB further usage data may be obtained from non-3GPP technology devices referred to as STA which stands for “station”, for example a WiFi device which is connected to a WiFi access point, AP. The gathered information on the resource usage, like a usage map or statistics or the like may be stored in a spectrum database which may be located at the gNB, at the CN, or which may be accessible by the CN. The spectrum database may be connected directly to the CN or via the internet, in the latter case, also the WiFi AP, which is connected to the Internet, may provide information on the resource usage to the spectrum database accessible via the Internet.

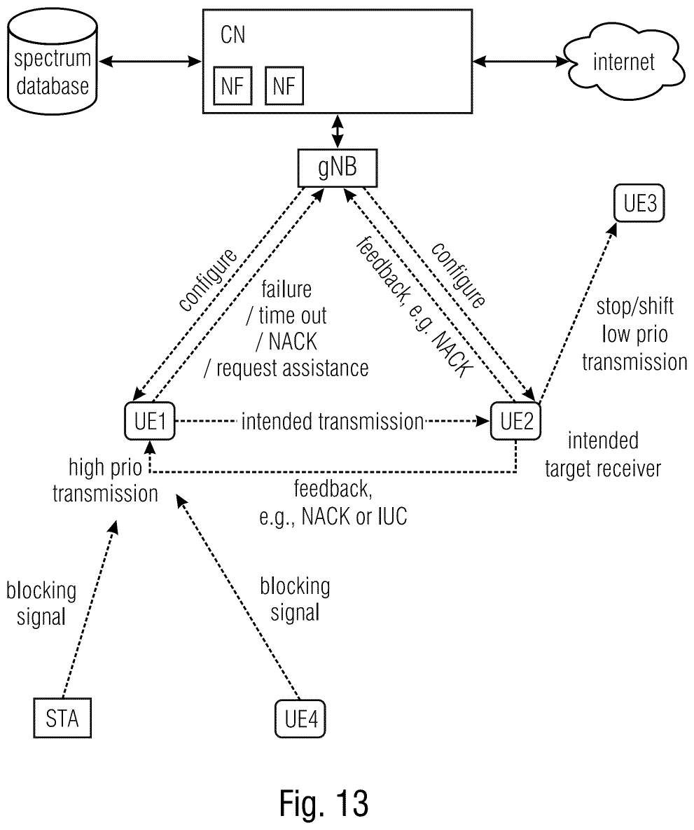

FIG. 13 illustrates an embodiment for a gNB-assisted coordination for avoiding or resolving LBT blocking in accordance with embodiments of the fourth aspect of the present invention. FIG. 13 illustrates a wireless communication network including the core network, CN, the RAN including the gNB, and the UEs UE1 to UE 4. In addition, a WiFi device STA is illustrated. The information about resource usage on the resources of the unlicensed spectrum is stored in the spectrum database and for resolving or reducing LBT blocking issues, dependent on messages received by the gNB, the gNB may assist a transmitting UE for transmitting a high priority transmission, or may reconfigure an intended receiver of the high priority transmission. Also, in accordance with other embodiments, the gNB may reconfigure other UEs so that LBT failures at the UE performing the high priority transmission are reduced. In one embodiment, the gNB might become aware that is has to assist by receiving assistance request from the UE performing the high priority transmission of from the intended target receiver of the high priority transmission. This may be in terms of a direct request message, or, alternatively, it may be in terms of a feedback message, e.g., HARQ feedback, received by one or more of the UEs, or both. In more detail, the gNB might receive a number of HARQ-NACKs from the intended target receiver, and might thus, decide to assist UE1 to perform its high priority transmission, e.g., by resolving UE1s LBT-blocking issue. In another embodiment, this request assistance may also be sent from UE1 to the gNB using a kind of special NACK message, as to make the gNB aware of the LBT-blocking issue. Furthermore, this message may also contain other information, e.g., information on the type of transmission of UE1, or information on the intended high priority transmission to UE2, e.g., number of transmissions or retransmissions or the message type used by UE1, such that the gNB may perform an adequate action as to resolve the LBT-blocking issue. In another embodiment, the gNB may also (re-)configure other UEs, such that possible transmissions blocking LBTs of high priority transmission are reduced. Furthermore, the gNB may also authorize or configure other UEs to inform another set of UEs, e.g., via PC5, to shift or stop low priority transmissions.

### General

Embodiments of the present invention have been described in detail above, and the respective embodiments and aspects may be implemented individually or two or more of the embodiments or aspects may be implemented in combination.

Further, aspects and embodiments of the present invention have been described in detail above with reference to a wireless communication network which may be a 3^{rd} Generation Partnership Project, 3GPP, network for which the transmissions described are over the sidelink, SL. However, the present invention is not limited to such networks. The above describes aspects and embodiments may also be implemented in any non-3GPP network. For example, in a WiFi network the WiFi stations, STAs, and WiFi access points, APs, may operate according to the described embodiments. Thus, blocking issues experienced by a WiFi STA may be addressed by implementing the above-described inventive mechanisms in the WiFi system.

In accordance with embodiments, the SL-UEs may perform the SL communication simultaneously using carrier aggregation (CA) or by using carrier switching utilizing one or more of
one or more high frequency bands, e.g., in FR2, using resources from a licensed spectrum and/or from an unlicensed spectrum, and/or
one or more low frequency bands, e.g., in FR1, using resources from a licensed spectrum and/or from an unlicensed spectrum.

Carrier aggregation (CA) utilizes more than one carrier simultaneously in the frequency domain. Carrier switching uses certain time resource within one frequency band, e.g., FR1, and in another time instance, resources within another frequency band, e.g., FR2. Carrier switching may save resources, e.g., power consumption in a device, while still allowing to use resources in more than one band. In general, control traffic may be sent very robust on a low frequency carrier, e.g., in FR1, while data exchange may occur on a high frequency carrier, FR2, allowing high data rate transmission in a wider frequency band.

In accordance with embodiments, the wireless communication system may include a terrestrial network, or a non-terrestrial network, NTN, or networks or segments of networks using as a receiver an airborne vehicle or a space-borne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity, a multi-RAT UE or a WiFi device, e.g., a AP or STA.

In accordance with embodiments of the present invention, a network entity comprises one or more of the following: a macro cell base station, or a small cell base station, or a central unit of a base station, an integrated access and backhaul, IAB, node, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

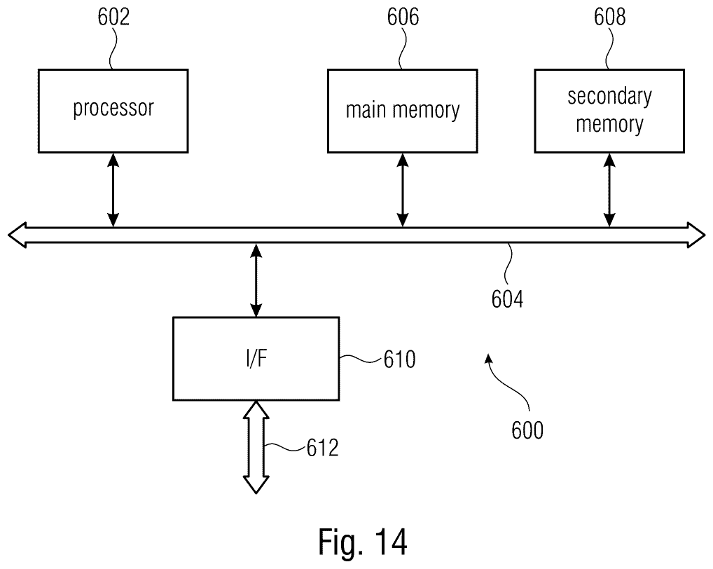

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 14 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A user device, UE, for a wireless communication network,
wherein the UE is to communicate with one or more further UEs in the wireless communication network using resources in an unlicensed spectrum,
wherein, for a transmission on a first set of resources in the unlicensed spectrum, the UE is to determine whether or not one or more resources of the first set of resources are reserved by a further UE for performing a certain transmission, and
wherein, responsive to determining that one or more resources of the first set of resources are not used by the further UE for performing the certain transmission, the UE is to perform COT sharing by occupying a channel within a first channel occupancy time, COT, and sharing the remaining COT of the first COT with the further UE, so as to allow the further UE to perform its certain transmission.

2. The user device, UE, of claim 1, wherein
the wireless communication network is a 3^{rd} Generation Partnership Project, 3GPP, network, and the transmission is over a sidelink, SL, or
the wireless communication network is a non-3GPP network, like a WiFi network.

3. The user device, UE, of claim 1, wherein the UE is to notify the other device by signaling:
information on the COT sharing, the information on the COT sharing comprising COT sharing parameters.

4. The user device, UE, of claim 1, wherein the UE is to perform the COT sharing only in case one or more of the following criteria are fulfilled:
the UE is within a certain range, e.g., a minimum required communication range, MCR, of the further UE,
the further UE comprises a certain UE identification, ID,
a duration or length of the first COT is sufficient for performing the transmission and the certain transmission,
the first set of resources comprises resources for which COT sharing is allowed,
the certain transmission was announced or reserved sufficiently ahead of the transmission,
the certain transmission comprises certain control and/or data, e.g., one or more of:
a physical sidelink shared channel, PSSCH,
a physical sidelink control channel, PSCCH,
a physical sidelink feedback channel, PSFCH,
an inter-UE coordination, IUC, message or IUC related data, e.g., one or more assistance information messages, AIMs, comprising, e.g., a set of preferred or non-preferred resources to be used by another UE,
a feedback message or feedback data, like an acknowledgement, ACK, and/or a non-acknowledgement, NACK, transmitted on, e.g., a physical sidelink feedback channel, PSFCH,
channel state information, CSI, feedback, e.g., channel quality information, CQI, a Signal-to-Interference-and-Noise Ratio, SINR, a Signal-to-Noise Ratio SNR, a Radio Signal Strength Indicator, RSSI, or a Reference Signal Received Power, RSRP,
broadcast or groupcast related messages,
feedback-free messages,
synchronization-related messages, e.g., transmitted via a physical sidelink broadcast channel, PSBCH,
beam-related information, e.g., information for beam management,
a high-layer marked message, e.g., an emergency message like a Decentralized Environmental Notification Message, DEMN, or a Cooperative Awareness Message, CAM,
a feedback message related to the Media Access Control, MAC, layer, or the Radio Resource Control, RRC, layer, or the Radio Link Control, RLC, layer, or the Packet Data Convergence Protocol, PDCP, layer,
the certain transmission has a priority higher than the priority of the transmission,
the certain transmission has a priority higher than the priority of the transmission and one or more defined or pre-defined properties, e.g., a duration being at or exceeding a certain threshold, or the priority further being at or exceeding a certain threshold, i.e., being very high,
the transmission has a priority that is below a certain threshold.

5. The user device, UE, of claim 1, wherein the wireless communication network is a 3GPP network, and the UE decide to perform the COT sharing dependent on one or more of the following:
a configuration of the resource pool, RP,
a CBR, e.g., the CBR being below a defined or pre-defined threshold,
whether or not a non-3GPP technology is present at the location of the UE, e.g., based on a geographical area or zone at which the UE is located or based on a channel measurement, e.g., a sensing result,
whether or not an absenceOfAnyOtherTechnology flag is set,
a mode in which the UE is operated, e.g., Mode 1 or Mode 2,
a cast type used by the UE,
a type of the transmission to be performed by the UE.

6. The user device, UE, of claim 5, wherein the UE is to perform and/or not to perform one or more of the actions dependent on whether or not a non-3GPP technology is present, e.g.,
in case no non-3GPP technology is present, the UE is not to perform COT sharing but only COT deferral, and
in case non-3GPP technology is present, the UE is not to perform COT deferral but only COT sharing.

7. The user device, UE, of claim 6, wherein, in case no non-3GPP technology is present, the UE is to perform the second CAP on
consecutive resources from the first set of resources which are not used by the certain transmission, e.g., resources following resources used by the certain transmission, in case a number of UEs operating on the resources in the unlicensed spectrum is below a certain threshold, or
resources different from the first set of resources, e.g., different frequency and/or time resources, in case the number of UEs operating on the resources in the unlicensed spectrum is at or above the certain threshold.

8. The user device, UE, of claim 1, wherein, when performing COT sharing, the UE is to receive COT sharing information from another device for a future transmission.

9. The user device, UE, of claim 1, wherein the certain transmission comprises
a data transmission having a priority exceeding a certain threshold, or
a transmission comprising particular control and/or data, e.g., one or more of:
feedback data, like an acknowledgement, ACK, and/or a non-acknowledgement, NACK, transmitted on, e.g., a physical sidelink
feedback channel, PSFCH,
channel state information, CSI, feedback, e.g., channel quality information, CQI, a Signal-to-Interference-and-Noise Ratio, SINR, a Signal-to-Noise Ratio SNR, a Radio Signal Strength Indicator, RSSI, or a Reference Signal Received Power, RSRP,
inter-UE coordination, IUC, related data, e.g., one or more assistance information messages, AIMs, comprising, e.g., a set of preferred or non-preferred resources to be used by another UE,
broadcast or groupcast related messages,
feedback-free messages,
synchronization-related messages, e.g., transmitted via a physical sidelink broadcast channel, PSBCH,
beam-related information, e.g., information for beam management,
a high-layer marked message, e.g., an emergency message like a Decentralized Environmental Notification Message, DEMN, or a Cooperative Awareness Message, CAM,
a feedback message related to the Media Access Control, MAC, layer, or the Radio Resource Control, RRC, layer, or the Radio Link Control, RLC, layer, or the Packet Data Convergence Protocol, PDCP, layer.

10. The user device, UE, of claim 1, wherein, for determining whether or not one or more of the first set of resources are reserved by the further UE for performing the certain transmission, the UE is to acquire information on the reserved resources according to one or more of the following:
from the wireless communication network, e.g., using AIMs,
by a sensing procedure performed by the UE, like an LBT,
from a received SCI, e.g., a 1^{st} stage SCI and or a 2^{nd} stage SCI,
from a received DCI,
by a signaling from a network entity, e.g., a base station or a road side-unit, RSU,
using an in-device coexistence framework, e.g., an LTE module inside a multi-RAT modem informs a NR module.

11. A method for operating a user device, UE, for a wireless communication network, wherein the UE is to communicate with one or more further UEs in the wireless communication network using resources in an unlicensed spectrum, the method comprising:
determining, for a transmission on a first set of resources in the unlicensed spectrum, whether or not one or more resources of the first set of resources are reserved by a further UE for performing a certain transmission, and
responsive to determining that one or more resources of the first set of resources are not used by the further UE for performing the certain transmission, performing COT sharing by occupying a channel within a first channel occupancy time, COT, and sharing the remaining COT of the first COT with the further UE, so as to allow the further UE to perform its certain transmission.
